(19) United States
(12) Patent Application Publication
(10) Pub. No.: US 2024/0316518 A1
(43) Pub. Date: Sep. 26, 2024

(54) Reactor Cell for Photocatalysis of Gaseous Species for Industrial Chemical Production

(71) Applicant: Syzygy Plasmonics Inc., Houston, TX (US)

(72) Inventors: Suman Khatiwada, Houston, TX (US); Shreya Shah, Houston, TX (US); Jack Elliot Hudson, Houston, TX (US); Hari Narayanan Rangarajan Thirumalai, Houston, TX (US); Jonathan Morris Chapman, Houston, TX (US); Trevor William Best, Houston, TX (US)

(73) Assignee: Syzygy Plasmonics Inc., Houston, TX (US)

(21) Appl. No.: 18/564,082

(22) PCT Filed: May 27, 2022
(86) PCT No.: PCT/US2022/031444

§ 371 Date: Nov. 25, 2023

Related U.S. Application Data
(60) Provisional application No. 63/202,099, filed on May 27, 2021.

(51) Int. Cl. B01J 8/02; B01J 8/00; B01J 8/06

(52) U.S. Cl. CPC B01J 8/0257; B01J 8/008; B01J 8/065; B01J 8/067; B01J 2208/00884

(57) ABSTRACT

A reactor cell assembly having an annular volume, a top endcap fitting having a reactant gas inlet, a bottom compression endcap fitting having a product gas outlet, a photocatalyst packed bed positioned in the annular volume, a porous base filter to position the photocatalyst packed bed in the annular volume, and a light housing. At least one of an outer portion and an inner portion of the light housing comprises a circumferential array of photon emitters arranged to uniformly emit photons incident on the photocatalyst packed bed to activate continuous photo-induced gas-phase reactions as at least one gaseous reactant introduced via the gas inlet flows through the photocatalyst packed bed and at least one resultant gaseous product exits via the gas outlet.

### FIELD

This disclosure relates to the field of industrial chemical production, and, in particular, to the design and construction of reactor cells for photocatalysis of gaseous species for industrial chemical production.

### BACKGROUND

Photocatalysis, as used herein, refers to irradiating a chemical process with photons to accelerate the rate of chemical conversion of reactants to selectively form a desired product. Incident photons of sufficient energy and wavelength activate photo-induced reactions by unlocking reaction mechanisms that otherwise may not be accessible via thermally activated processes. Recent developments in photocatalysis include the use of plasmonic nanoparticles that exhibit strong interactions with visible light due to the excitation of electronic oscillations. See, e.g., the following, the contents of each of which is incorporated by reference herein: (1) Stankiewicz, “Energy Matters: Alternative Sources and Forms of Energy for Intensification of Chemical and Biochemical Processes,” Chem. Eng. Res. Des., 2006, 84 (7 A), 511-521, https://doi.org/10.1205/cherd.05214; (2) Robatjazi et al., “Plasmon-Driven Carbon-Fluorine (C(Sp 3)—F) Bond Activation with Mechanistic Insights into Hot-Carrier-Mediated Pathways,” Nat. Catal., 2020, 3 (7), 564-573, https://doi.org/10.1038/s41929-020-0466-5; (3) Zhou et al., “Light-Driven Methane Dry Reforming with Single Atomic Site Antenna-Reactor Plasmonic Photocatalysts,” Nat. Energy, 2020, 5 (1), 61-70, https://doi.org/10.1038/s41560-019-0517-9; (4) Gerven et al., “2009-VanGervenStankiewicz-Structure, Energy, Synergy, Time.pdf,” 2009, 2465-2474; and (5) Zhou et al., “Quantifying Hot Carrier and Thermal Contributions in Plasmonic Photocatalysis,” Science, 5 Oct. 2018, 69-72, https://doi.org/10.1126/science.aat6967. These plasmonic nanoparticles offer the possibility of increased efficiency due to increased selectivity to desired products at reduced energy consumption. While plasmonic nanoparticles have attracted significant interest in academia for various chemical transformations, known industrial applications are limited to wastewater treatment and purification processes, all of which are liquid-state reactions. See, e.g., Mozia, “Photocatalytic Membrane Reactors (PMRs) in Water and Wastewater Treatment: A Review,” Sep. Purif. Technol., 2010, 73 (2), 71-91, https://doi.org/10.1016/j.seppur.2010.03.021, the entirety of which is incorporated by reference herein.

Conversely, thermal catalysis is responsible for the production of approximately 85% of all industry-produced chemicals. However, thermal catalysis typically requires relatively extreme reaction conditions, including high temperatures and pressures, resulting in reduced process efficiency and a large carbon footprint.

Combining photocatalysis with thermal catalysis in a cooperative manner offers the possibility of increasing product selectivity while reducing the energy requirement for the process. However, considerable engineering challenges accompany combining photon sources and heaters into a single modular system, and therefore, photothermal catalytic systems have been studied predominantly in academia. See, e.g., Nair et al., “Thermo-Photocatalysis: Environmental and Energy Applications,” ChemSusChem, 2019, 12 (10), 2098-2116, https://doi.org/10.1002/cssc.201900175, the entirety of which is incorporated by reference herein.

Needed are improved reactor designs for photocatalysis and photothermal catalytic systems for industrial chemical production.

### SUMMARY

One embodiment set forth herein is directed to a photocatalytic reactor cell assembly that includes an outer cell wall and an inner cell wall. The outer cell wall and the inner cell wall are arranged concentrically about a vertical axis to define an annular volume between the outer cell wall and the inner cell wall. A top endcap fitting having a reactant gas inlet and a bottom endcap fitting having a product gas outlet respectively form a top seal and a bottom seal with the outer cell wall and the inner cell wall. A photocatalyst packed bed is positioned in the annular volume between the outer cell wall and the inner cell wall by a porous base filter. A light housing includes photon emitters arranged to uniformly emit photons incident on the photocatalyst packed bed in order to activate continuous photo-induced gas-phase reactions as at least one gaseous reactant introduced via the gas inlet flows through the photocatalyst packed bed and at least one resultant gaseous product exits via the gas outlet.

One or more cooling structures and/or mechanisms may be provided to provide cooling to the photon emitters and/or to portions of the light housing on which the photon emitters are mounted.

One or more heaters may be provided to heat the photocatalyst packed bed, to increase the reaction rate of photo-induced gas-phase reactions.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

The accompanying drawings are included to provide a further understanding of the systems, apparatus, devices, and/or methods of the disclosure, and are incorporated in and constitute a part of this specification. The drawings are not necessarily to scale, and sizes of various elements may be distorted for clarity and/or illustrated as simplistic representations to promote comprehension. The drawings illustrate one or more embodiments of the disclosure, and together with the description, serve to explain the principles and operation of the disclosure.

FIG. 1 is an isometric diagram illustrating a photocatalytic reactor cell assembly, according to an example embodiment.

FIG. 2 is a vertical cross-sectional diagram illustrating a photocatalytic reactor cell assembly, according to an example embodiment.

FIG. 3 is a horizontal cross-sectional diagram illustrating a photocatalytic reactor cell assembly, according to an example embodiment.

FIG. 4 is a vertical cross-sectional diagram illustrating a photocatalytic reactor cell assembly, according to an example embodiment.

FIG. 5 is an isometric diagram illustrating a photocatalytic reactor cell assembly, according to an example embodiment.

FIG. 6 is a vertical cross-sectional diagram illustrating a photocatalytic reactor cell assembly, according to an example embodiment.

FIG. 7 is an isometric diagram illustrating a photocatalytic reactor cell assembly, according to an example embodiment.

FIG. 8 is an elevational diagram illustrating a photocatalytic reactor cell assembly, according to an example embodiment.

FIG. 9 is an isometric diagram illustrating a photocatalytic reactor cell assembly, according to an example embodiment.

FIG. 10 is a vertical cross-sectional diagram illustrating a photocatalytic reactor cell assembly, according to an example embodiment.

FIG. 11 is a horizontal cross-sectional diagram illustrating a photocatalytic reactor cell assembly, according to an example embodiment.

FIG. 12 is an elevational diagram illustrating a single IR lamp that may be used as a photon emitter and/or heater component, according to an example embodiment.

FIG. 13 is a horizontal cross-sectional schematic diagram illustrating a single IR lamp that may be used as a photon emitter and/or heater component, according to an example embodiment.

FIG. 14 is a table setting forth three categories of infrared radiation for industrial applications.

FIG. 15 is a graph illustrating percentage of radiation transmission as a function of wavelength for quartz.

FIG. 16 is a graph illustrating absorbance of IR radiation for various gaseous species as a function of wavelength.

FIG. 17 is an isometric diagram illustrating a photocatalytic reactor cell assembly, according to an example embodiment.

FIG. 18 is a vertical cross-sectional diagram illustrating a photocatalytic reactor cell assembly, according to an example embodiment.

FIG. 19 is a horizontal cross-sectional diagram illustrating a photocatalytic reactor cell assembly, according to an example embodiment.

FIG. 20 is an isometric diagram illustrating a photocatalytic reactor cell assembly, according to an example embodiment.

FIG. 21 is a vertical cross-sectional diagram illustrating a photocatalytic reactor cell assembly, according to an example embodiment.

FIG. 22 is a horizontal cross-sectional diagram illustrating a photocatalytic reactor cell assembly, according to an example embodiment.

FIG. 23 is an isometric diagram illustrating a photocatalytic reactor cell assembly, according to an example embodiment.

FIG. 24 is a vertical cross-sectional diagram illustrating a photocatalytic reactor cell assembly, according to an example embodiment.

FIG. 25 is a horizontal cross-sectional diagram illustrating a photocatalytic reactor cell assembly, according to an example embodiment.

FIG. 26 is an isometric diagram illustrating a photocatalytic reactor cell assembly, according to an example embodiment.

FIG. 27 is a vertical cross-sectional diagram illustrating a photocatalytic reactor cell assembly, according to an example embodiment.

FIG. 28 is a horizontal cross-sectional diagram illustrating a photocatalytic reactor cell assembly, according to an example embodiment.

FIG. 29 is an isometric diagram illustrating a photocatalytic reactor cell assembly, according to an example embodiment.

FIG. 30 is an isometric diagram illustrating a photocatalytic reactor cell assembly, according to an example embodiment.

FIG. 31 is a vertical cross-sectional diagram illustrating a photocatalytic reactor cell assembly, according to an example embodiment.

FIG. 32 is a horizontal cross-sectional diagram illustrating a photocatalytic reactor cell assembly, according to an example embodiment.

FIG. 33 is a vertical cross-sectional diagram illustrating detail of a top seal for a photocatalytic reactor cell assembly, according to an example embodiment.

FIG. 34 is a vertical cross-sectional diagram illustrating detail of a top seal for a photocatalytic reactor cell assembly, according to another example embodiment.

FIG. 35 is a vertical cross-sectional diagram illustrating detail of a top seal for a photocatalytic reactor cell assembly according to yet another example embodiment.

### DETAILED DESCRIPTION

Example systems, apparatus, devices, and/or methods are described herein. It should be understood that the word “example” is used to mean “serving as an example, instance, or illustration.” Any embodiment or feature described herein as being an “example” is not necessarily to be construed as preferred or advantageous over other embodiments or features unless stated as such. Thus, other embodiments can be utilized, and other changes can be made, without departing from the scope of the subject matter presented herein. The aspects described herein are not limited to specific embodiments, apparatus, or configurations, and as such can, of course, vary. It should be readily understood that the aspects of the present disclosure, as generally described herein, and illustrated in the figures, can be arranged, substituted, combined, separated, and designed in a wide variety of different configurations. It is also to be understood that the terminology used herein is for the purpose of describing particular aspects only, and unless specifically defined herein, is not intended to be limiting.

Throughout this specification, unless the context requires otherwise, the words “comprise” and “include” and variations (e.g., “comprises,” “comprising,” “includes,” “including,” “has,” and “having”) will be understood to imply the inclusion of a stated component, feature, element, or step or group of components, features, elements, or steps, but not the exclusion of any other component, feature, element, or step or group of components, features, elements, or steps.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

As used in the specification and the appended claims, the singular forms “a,” “an,” and “the” include plural referents unless the context clearly dictates otherwise.

Ranges can be expressed herein as from “about” one particular value and/or to “about” another particular value. When such a range is expressed, another aspect includes from the one particular value and/or to the other particular value. Similarly, when values are expressed as approximations by use of the antecedent “about,” it will be understood that the particular value forms another aspect. It will be further understood that the endpoints of each of the ranges are significant both in relation to the other endpoint and independently of the other endpoint.

Any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

### I. Overview

Effective, functional photocatalytic reactors are designed such that catalyst contacted with the reactant is uniformly illuminated by a photon source, thus driving the chemical reaction. Irradiation of light could be achieved by using natural (e.g., solar) or artificial sources of light (e.g., IR lamps, UV lamps, arc lamps, or light emitting diodes (LEDs). Typical reactor configurations include slurry reactors, annular reactors, immersion reactors and optical fiber/tube reactors. See, e.g., Van Gerven et al., “A Review of Intensification of Photocatalytic Processes,” Chem. Eng. Process. Process Intensif., 2007, 46 (9 SPEC. ISS.), 781-789, https://doi.org/10.1016/j.cep.2007.05.012, the entirety of which is incorporated by reference herein. Challenges to process intensification of these reactors mainly arise from photon and mass transfer limitations. Research into photocatalytic reactors for the conversion of gaseous species is still in its infancy, and the present applicants are not aware of any reported examples of a successful scale-up of a laboratory set-up to an industrially relevant scale. Difficulties in reactor design, material selection, and an incomplete understanding of the critical parameters that are important to reactor design have hampered past development efforts. See, e.g., de Lasa et al., “Photocatalytic Reaction Engineering,” Springer, Boston, M A, 2005, https://doi.org/i0.1007/0-387-27591-6.

Several large-scale photocatalytic reactors have been proposed, and of these designs, slurry reactors, annular reactors, immersion reactors, and optical tube reactors have been tested in the area of wastewater treatment, for liquid state reactions only. See, e.g., de Lasa et al., “Photocatalytic Reaction Engineering,” Springer, Boston, M A, 2005. The light source in such reactors is oriented such that it illuminates the longitudinal axis of the reactors to drive the photocatalytic treatment of wastewater. The catalyst in the reactor is either fluidized by the wastewater or immobilized by support material. Commonly reported drawbacks associated with these types of reactors center around the lack of uniform irradiance of the photocatalyst and mass transfer limitations associated with insufficient contact between the photocatalyst and the fluid. Strategies to improve mixing and overcome mass transfer limitations include the use of rotors and/or impellers in the reactor to create turbulent fluid flow. See, e.g., U.S. Patent Application Publication No. US20130008857A1. More recently, photocatalytic reactors are being used for the removal of volatile organic components as part of air purification modules. See, e.g., U.S. Patent Application Publication No. US20210023255A1. These reactor designs incorporate “fins” or directional blades to improve mass transfer and contacting of the air with the coated photocatalyst.

Implementation of these processes at a larger scale than that studied in research and development settings has been stymied for a variety of reasons. Photocatalytic reactor development has not had the decades of experience associated with thermal catalytic reactors. A sound understanding of the fundamental processes underlying thermal catalytic reactors simplifies the scaleup of a lab-scale thermal catalytic reactor process to the pilot scale and beyond. Thermal catalytic reactors also benefit from proven numerical and kinetic modeling. Conversely, investigations into photocatalytic and photo-thermal catalytic processes have instead focused on clarifying product formation and reaction kinetics, as well as obtaining a mechanistic understanding of the underlying chemistry. The inclusion of photons in photocatalysis causes significant deviations in reactor performance from traditional thermal catalytic reactors. Added complexities include the selection of suitable light sources and reactor geometries (which affects photon behavior and catalytic performance of the process). These unknowns add significant variability to scale-up and process intensification. See, e.g., Pasquali et al., “Radiative Transfer in Photocatalytic Systems,” AIChE J., 1996, 42 (2), 532-537, https://doi.org/10.1002/aic.690420222, and Alfano et al., “Photocatalysis in Water Environments Using Artificial and Solar Light,” 2000; Vol. 58, https://doi.org/10.1016/S0920-5861(00)00252-2, both of which are incorporated by reference herein.

Other complexities have contributed to the relatively slow development of photocatalytic reactor designs. See, e.g., Su et al., “Photochemical Transformations Accelerated in Continuous-Flow Reactors: Basic Concepts and Applications,” Chem. -A Eur. J., 2014, 20 (34), 10562-10589. https://doi.org/10.1002/chem.201400283, the entirety of which is incorporated by reference herein. One such consideration includes the choice of material for reactor cell construction, as photocatalytic processes require transparent windows for light or photons to irradiate the catalyst. Reactor geometries should also be optimized for photon transport such that light losses are minimized and photon flux is concentrated toward the catalyst bed. A photocatalytic reactor cell design should also be able to facilitate gas-solid mixing and transport characteristics to promote optimal catalytic performance. Fabrication of stainless steel and glass-based pilot-scale photocatalytic reactors within design specifications is an engineering challenge that has been an obstacle to further development. Inclusion of reflective materials, control electronics for photon sources, and auxiliary processes to support photocatalytic reactor functions have added considerable complexity to the development of photocatalytic reactors.

To address some of the shortcomings of prior photocatalytic reactor cells, disclosed herein are various embodiments of an improved reactor cell assembly for photocatalysis of gaseous species for industrial chemical production. The disclosed reactor cell embodiments include example reactor cells capable of performing chemical reactions with gaseous feed using incident photons (i.e., light) over a packed bed of photocatalyst placed in the annulus of a reactor cell having outer and inner cell walls. In some example embodiments, one or both of the outer and inner cell walls are transparent. Other reactor cell embodiments are also described herein.

Example embodiments set forth herein are generally directed to a photocatalytic reactor cell that is annular in nature, with a nanoparticle photocatalyst packed bed. The annular region may be made of materials transparent in the visible and near IR region. The gaseous reactants flow through the packed photocatalyst bed similar to as in a plug-flow reactor, allowing for continuous reaction and generation of the desired product. The energy to the photocatalyst may be provided on one or both sides (i.e., exterior and/or interior) of the annular region via a light housing having many photon emitters, such as Light Emitting Diodes (LEDs) or IR lamps, mounted on or serving as portions of the light housing, for example. The specific geometry and use of transparent or reflective or scattering materials allows for an efficient way of transmitting light energy to the photocatalyst, to promote efficient chemical reactions. In some embodiments, the light housing may include a cooling assembly to assist in cooling the photon emitters and/or surfaces on which the photon emitters are mounted. In some other embodiments, one or more heaters may be included to increase the photocatalytic reaction rate.

Some embodiments set forth herein allow for reduced dependency on fossil fuels and reduced carbon emissions. For example, embodiments having LEDs as photon emitters may utilize electricity for activation of the LEDs. Such electricity may be generated using renewable resources, such as solar-, hydro-, or wind-generated power. As a result, environmental benefits may be realized for industrial chemical reactions that have conventionally been performed via thermal catalysis using heat energy generated by burning of fossil fuels.

The chemical reactions that can be performed in various embodiments of the reactor cells described herein conventionally require very high temperatures due to high enthalpy of reaction. Conventional thermal catalytic reactors are typically made of relatively expensive materials that can sustain such high temperatures. In addition, conventional thermal catalytic reactors are typically imparted with heat energy in an inefficient and environmentally unfriendly manner via burning of fossil fuels. Conversely, various reactor cell embodiments described herein can assist in performing these same chemical reactions in the presence of visible light at much lower temperatures than required for conventional thermal catalytic reactors. This enables the use of relatively inexpensive materials, such as glass or aluminum, for the construction of the reactor. Additionally, the accompanying lower operating temperatures may prolong the lifespan of reactor components for the example photocatalytic reactors described herein.

The various reactor cell assembly embodiments set forth herein may serve as a platform technology allowing for multiple gas-phase chemical reactions requiring high enthalpy of reaction and high activation energy via the use of light energy. For example, the following is a non-exclusive list of reactions and reaction types possible using one or more example embodiments set forth herein:
1. Steam methane reforming.
2. Dry methane reforming.
3. Partial oxidation of methane.
4. Autothermal reforming.
5. Decomposition of ammonia.
6. Ammonia synthesis.
7. Water gas shift reactions.
8. Reverse water gas shift reactions.
9. Reforming of heavier hydrocarbons (e.g., alkylated cyclics, resins and
asphaltenes).
10. Fischer-Tropsch synthesis.
11. Methanol synthesis.
12. Ethanol synthesis.
13. Hydrogenation to make saturated compounds.
14. Dehydrogenation to make ethylene.
15. Breaking of carbon-halogen bonds, such C—F, C≡CI, C—I.

### II. Reactor Cell Assembly for Photocatalysis of Gaseous Species

A. Reactor Cell Assembly having Cooled Outer and Inner LED Light Housing

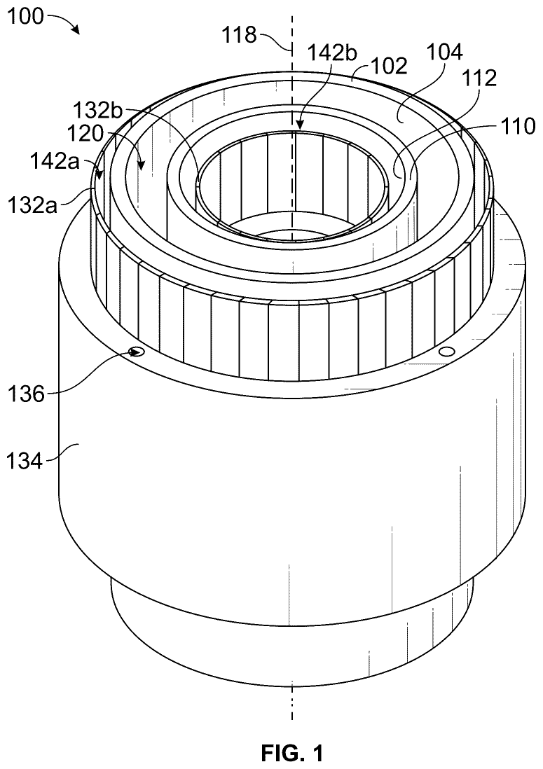

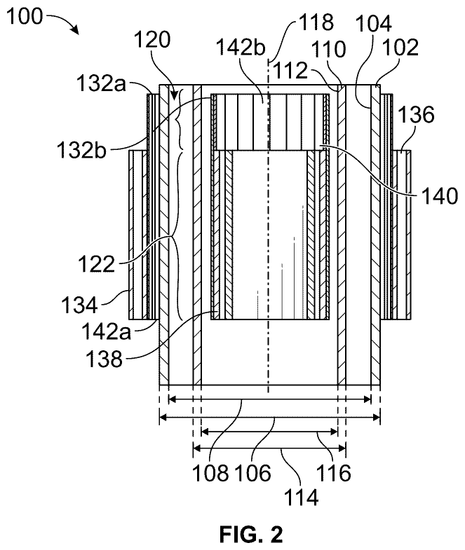

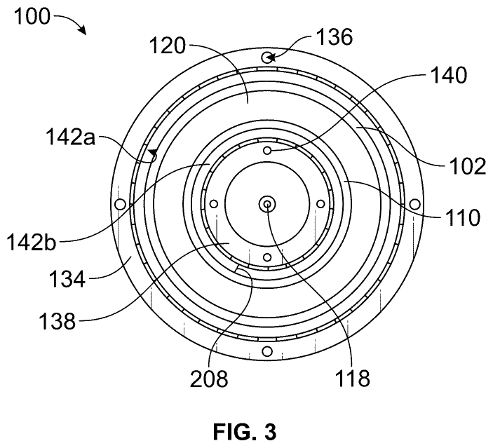

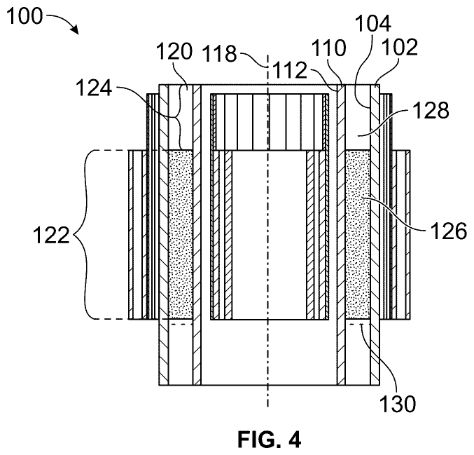

FIG. 1 is an isometric diagram illustrating a photocatalytic reactor cell assembly 100, according to a first example embodiment. FIG. 2 is a vertical cross-sectional diagram illustrating the photocatalytic reactor cell assembly 100, according to the first example embodiment. FIG. 3 is a horizontal cross-sectional diagram illustrating the photocatalytic reactor cell assembly 100, according to the first example embodiment. FIG. 4 is a vertical cross-sectional diagram illustrating the photocatalytic reactor cell assembly 100 with installed photocatalyst, according to the first example embodiment. The following description of the first example embodiment references features and components shown in one or more of FIGS. 1-4, where like reference numerals refer to like features and components. As with all figures referenced herein, one or more of FIGS. 1-4 may omit some features and/or components, as appropriate, to permit better illustration and comprehension.

As illustrated, the photocatalytic reactor cell assembly 100 includes an outer cell wall 102 comprising a first tube 104 having a first outer diameter 106 and a first inner diameter 108. The photocatalytic reactor cell assembly 100 also includes an inner cell wall 110 comprising a second tube 112 having a second outer diameter 114 and a second inner diameter 116, where the second outer diameter 114 is smaller than the first inner diameter 108. The outer cell wall 102 and the inner cell wall 110 are arranged concentrically about a vertical axis 118 to define an annular volume 120 between the outer cell wall 102 and the inner cell wall 110.

In the example of FIGS. 1-4 (and other embodiments illustrated herein), the first tube 104 and the second tube 112 are cylindrical, with a circular cross section. In other embodiments, the first tube 104 and/or the second tube 112 may have a shape that is non-cylindrical. For example, one or both of the first tube 104 or the second tube 112 may be constructed of tubing having a square, hexagonal, octagonal, or other regular polygonal cross-section. For embodiments utilizing non-circular cross sections for the first tube 104 and/or the second tube 112, the term “diameter” is intended to refer to a perpendicular distance between the vertical axis 118 and a side (or corner) of the first tube 104 and/or the second tube 112, and the term “annular volume” is intended to refer to the regular-shaped volume between the outer cell wall 102 and the inner cell wall 110. Moreover, the first outer diameter 106 and/or the first inner diameter 108 of the first tube 104 may vary over the height (length) of the first tube 104, such as may be the case if a middle portion of the first tube 104 is wider than end portions. Similarly, the second outer diameter 114 and second inner diameter 116 of the second tube 112 may vary over the height (length) of the second tube 112. For example, the first tube 104 and/or the second tube 112 may have two or more cylindrical portions of differing diameters, with each of the cylindrical portions being joined end-to-end via angular connecting portions that serve as size-adapters between the different cylindrical portions.

For the embodiment illustrated in FIGS. 1-4, at least portions of both the outer cell wall 102 and the inner cell wall 110 are constructed of a material that is transparent to photons emitted by photon emitters (described in further detail below). For example, the outer cell wall 102 and the inner cell wall 110 may be constructed of a material that is transparent to photons in the visible light spectrum. As another example, the outer cell wall 102 and the inner cell wall 110 may be constructed of a material that is transparent to photons in the near-infrared (near-IR) spectrum. As such, the outer cell wall 102 and/or the inner cell wall 110 may be constructed of one or more of the following, without limitation: glass, fused quartz glass, borosilicate glass, or a metallic material. As another alternative, the outer cell wall 102 and/or the inner cell wall 110 may be constructed of a transparent ceramic material, such as one of the materials described in Kachaev, A. A., Grashchenkov, D. V., Lebedeva, Y. E. et al. Optically Transparent Ceramic (Review). Glass Ceram 73, 117-123 (2016). https://doi.org/10.1007/s10717-016-9838-3. In an embodiment utilizing heating only (and not photon emissions) adjacent to either or both of the outer cell wall 102 and/or the inner cell wall 110, the outer cell wall 102 and/or the inner cell wall 110 may comprise coated or polished metal (e.g., stainless steel or aluminum).

As shown in FIGS. 2 and 4, the annular volume 120 between the outer cell wall 102 and the inner cell wall 110 may include two or more portions along its height (length), including a middle portion 122 and an upper portion 124. The middle portion may be filled with a photocatalyst packed bed 126, as shown in FIG. 4, while the upper portion 124 may serve as a headspace 128 to allow for reactant gas mixing. The upper portion 124 may be empty, as shown in FIG. 4, or it may be occupied, at least partially, by a gas mixing material, such as quartz wool, SiC, or beads (e.g., alumina beads and/or silica beads). Additionally, the upper portion 124 may be heated, such as via one or more internal heaters and/or external clamp heaters (not shown).

The photocatalyst packed bed 126 is positioned in the annular volume 120 between the outer cell wall 102 and the inner cell wall 110. The photocatalyst packed bed 126 has a photocatalyst on a support material. For example, the photocatalyst packed bed 126 may include a photocatalyst co-precipitated with a support material. The photocatalyst may comprise antenna-reactor plasmonic nanoparticles, for example. Various antenna-reactor catalysts developed by Rice University are described in U.S. Pat. No. 10,766,024 (incorporated by reference herein) and can effectively utilize light energy to perform various chemical reactions. For example, such antenna-reactor catalysts can be used in the reactor cell embodiments described herein to provide high conversion at high space velocity, resulting in a high hydrogen production rate per unit volume of catalyst bed. Depending on the type of chemical reaction to be performed, an appropriate antenna-reactor catalyst can be matched with correspondingly appropriate LED diodes to efficiently activate the photocatalyst, thereby resulting in high reaction rates. For example, in the case of Photocatalytic Steam Methane Reformation (PSMR), a high reaction rate equivalent to 270 micromoles/g/s has been achieved using an appropriate photocatalyst in reactor cell embodiments described herein.

In some embodiments, only a portion of the outer cell wall 102 and/or the inner cell wall 110 is transparent to photons. This transparent portion of the outer cell wall 102 and/or the inner cell wall 110 may correspond to the middle portion 122 of the annular volume 120 illustrated in FIGS. 2 and 4, such that the transparent portion of the outer cell wall 102 and/or the inner cell wall 110 is directly adjacent to the photocatalyst packed bed 126. For example, in one embodiment, at least a first portion of at least one of the outer cell wall 102 and the inner cell wall 110 is constructed of a material that is transparent to the photons emitted by the photon emitters, while at least a second portion of at least one of the outer cell wall 102 and the inner cell wall 110 includes one or more reflective surfaces to reflect any emitted wayward photons into the photocatalyst packed bed 126. In another example embodiment, at least a first portion of at least one of the outer cell wall 102 and the inner cell wall 110 is constructed of a material that is transparent to the photons emitted by the photon emitters, while at least a second portion of at least one of the outer cell wall 102 and the inner cell wall 110 includes one or more scattering surfaces to scatter any emitted wayward photons into the photocatalyst packed bed 126. The “second portion” referenced in each of the previous two described embodiments may correspond to the upper portion 124 of the annular volume 120 illustrated in FIGS. 2 and 4, such that the second portion is directly adjacent to the headspace 128, and/or to a portion of the annular volume 120 that is below the photocatalyst packed bed 126 (i.e., on the opposite side of the photocatalyst packed bed 126 from the headspace 128). In yet another example embodiment, both reflective and scattering surfaces may be included in the outer cell wall 102 and/or the inner cell wall 110, or in other components of the photocatalytic reactor cell 100.

The use of reflective and/or scattering surfaces may help to minimize heat losses from the reactor cell assembly 100. Based on multiphysics simulation modeling using COMSOL, it has been determined that heat losses may be minimized using one or more of the following principles: (a) utilizing appropriate materials at different parts of the reactor to minimize or advantageously re-use the radiative heat transferred from the energized catalyst bed to other parts of the reactor; (b) utilizing appropriate insulation materials at different parts of the reactor; (c) minimizing the use of metal in the reactor and instead using materials with lower thermal conductivity (e.g., glass or quartz), thus increasing the resistance to heat transfer from the photocatalytic reactor cell assembly 100 to the environment. The reactor cell embodiments described herein operate at much lower temperatures then conventional thermal reactors, allowing for the use of materials such as quartz, aluminum, and ceramics. This may reduce the loss of energy from reactor cell assembly 100, thus potentially increasing energy efficiency compared to conventional reactors.

As illustrated in FIG. 4, a porous base filter 130 may be included in the annular volume 120 between the outer cell wall 102 and the inner cell wall 110 to position the photocatalyst packed bed 126 in the annular volume 120. When the photocatalytic reactor cell assembly 100 is oriented vertically (perpendicular to the ground) with respect to a gravitational or other force (not shown but assumed to be originating from the bottom of FIG. 4), the porous base filter 130 is preferably located at an underside (i.e., bottom) of the photocatalyst packed bed 126. The porous base filter 130 has a plurality of openings (pores) having a pore size chosen to be gas-permeable (to allow resultant gaseous product(s) to flow through) but impermeable to the photocatalyst packed bed 126. For example, the pore size is chosen to be impermeable to the micron-sized aggregates of the photocatalyst nanoparticles and support material (e.g., aerogel) in the photocatalyst packed bed 126. The porous base filter 130 is constructed of a gas-permeable structural material, such as one of the following, without limitation: porous metal, stainless steel (SS316), an austenitic nickel-chromium-based alloy, a nickel-chromium-iron-molybdenum alloy, quartz wool, or ceramic. If both the outer cell wall 102 and the inner cell wall 110 are cylindrical, then the porous base filter 130 preferably has an annular shape corresponding to the shape of the annular volume 120.

Table 1, below, sets forth example physical dimensions for various example reactor cell embodiments set forth herein:

TABLE 1

| Dimensions | Range | Unit |
|---|---|---|
| Height | 5-200 | cm |
| Annular region inside | 5-275 | cm |
| cylinder inside diameter | | |
| Annular region inside | 5.5-300 | cm |
| cylinder outside diameter | | |
| Annular region outside | 6-300 | cm |
| cylinder inside diameter | | |
| Annular region outside | 6.5-330 | cm |
| cylinder inside diameter | | |
| Catalyst Bed Volume | 0.25-15 | L |

The photocatalytic reactor cell 100 illustrated in FIGS. 1-4 includes a light housing comprising an outer portion 132a and an inner portion 132b. While both an outer portion 132a and an inner portion 132b of the light housing are illustrated, in some embodiments, either of the outer portion 132a or the inner portion 132b may be omitted from the light housing. The outer portion 132a of the light housing is arranged concentrically around the vertical axis 118 outside the outer cell wall 102. The inner portion 132b of the light housing is arranged concentrically around the vertical axis 118 inside the inner cell wall 110. In the example of FIGS. 1-4, both the outer portion 132a and the inner portion 132b have a circumferential array of photon emitters arranged to uniformly emit photons incident on the photocatalyst packed bed 126. The circumferential array of photon emitters 142a of the outer portion 132a of the light housing is arranged to emit photons toward the photocatalyst packed bed 126 (i.e., toward an interior of the outer portion 132a). The circumferential array of photon emitters 142b of the inner portion 132b of the light housing is arranged to emit photons toward the photocatalyst packed bed 126 (i.e., generally away from an interior of the inner portion 132b). For example, the circumferential array of photon emitters 142a may be arranged on an inner surface of the outer portion 132a and the circumferential array of photon emitters 142b may be arranged on an outer surface of the inner portion 132b, in order to uniformly emit photons incident on the photocatalyst packed bed 126. As another example, the circumferential array of photon emitters 142a may be arranged as a plurality of bulbs emitting photons toward an interior of the outer portion 132a and the circumferential array of photon emitters 142b may be arranged as a plurality of bulbs emitting photons toward an exterior of the inner portion 132b, in order to uniformly emit photons incident on the photocatalyst packed bed 126. The emission of photons incident on the photocatalyst packed bed 126 activates continuous photo-induced gas-phase reactions as at least one gaseous reactant flows through the photocatalyst packed bed 126, producing at least one resultant gaseous product.

In some example embodiments, the outer portion 132a of the light housing is of an outwardly opening clamshell design and comprises two (or more) sections coupled by a hinge (not shown) to allow for installation or removal of the outer portion 132a in the photocatalytic reactor cell assembly 100. Similarly, the inner portion 132b of the light housing may be of an inwardly opening clamshell design comprising two (or more) sections coupled by a hinge (not shown) to allow for installation or removal of the inner portion 132b in the photocatalytic reactor cell assembly 100.

As illustrated in FIGS. 1-4, both the outer portion 132a and the inner portion 132b of the light housing are cylindrical, with a circular cross section. In other embodiments, the outer portion 132a and/or the inner portion 132b of the light housing may have a shape that is non-cylindrical. For example, the outer portion 132a and/or the inner portion 132b of the light housing may have a square, hexagonal, octagonal, or other regular polygonal cross-section, such as to match a cross-sectional shape of the first tube 104 and/or the second tube 112. Moreover, the cross-sectional widths of the outer portion 132a and/or the inner portion 132b may vary over the height (length) of the outer portion 132a and/or the inner portion 132b, such as may be the case if a middle portion of the outer portion 132a and/or the inner portion 132b is wider than end portions. For example, the outer portion 132a and/or the inner portion 132b may have two or more cylindrical portions having different diameters, with each of the cylindrical portions being joined end-to-end via angular connecting portions that serve as size-adapters between the different cylindrical portions the outer portion 132a and/or the inner portion 132b of the light housing.

The exterior of the outer portion 132a of the light housing may be shaped differently than the interior of the outer portion 132a. For example, instead of being cylindrically shaped on both its interior and exterior, the outer portion 132a may be cylindrical on its interior, but surrounded by other equipment, components, and/or materials, such as heat management and/or control equipment, components, and/or materials, giving the exterior a non-cylindrical shape. Similarly, the interior of the inner portion 132b of the light housing may be shaped differently than the exterior of the inner portion 132b. For example, instead of being generally hollow as shown in FIGS. 1-4, the inner portion 132b may instead be solid or filled with other equipment, components, and/or materials.

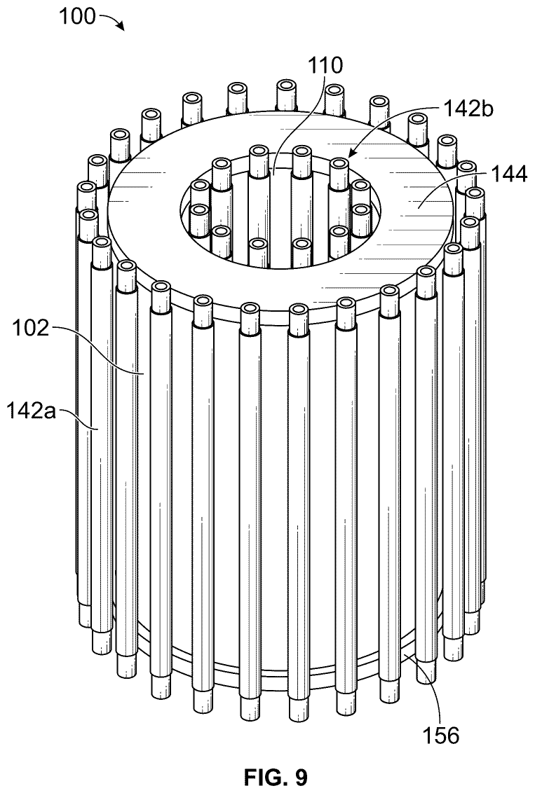

Some or all of the photon emitters in the circumferential array of photon emitters on the outer portion 132a and/or the inner portion 132b may be LEDs mounted on LED circuit boards or in other configurations, as is illustrated in FIGS. 1-4 and several other figures herein. For example, the circumferential array of photon emitters on the outer portion 132a and/or the inner portion 132b may include a plurality of LED boards adjacent to one another, with each LED board comprising a plurality of LEDs, such as thousands of LEDs that are each around 1-5 mm across. The LEDs may be selected to emit photons in the visible light spectrum (i.e., from about 380 nm to about 750 nm), for example. Alternatively or additionally, some or all of the photon emitters in the circumferential array of photon emitters on the outer portion 132a and/or the inner portion 132b may be infrared (IR) lamps mounted via sockets, connectors, pins, wires, or other configurations, to emit photons in the near-IR spectrum (i.e., from about 750 nm to about 2,500 nm). Further details regarding the use of IR bulbs as photon emitters (and/or heaters) are presented with respect to FIGS. 9-16, among others. Other embodiments may include other types of photon emitters, both artificial (e.g., ultraviolet (UV) lamps and voltaic arc lamps) and natural (e.g., utilizing solar radiation). In general, to promote efficient operation for the photocatalytic reactor cell assembly 100, the photon emitters are selected to emit photons having a sufficient energy and wavelength to activate desired photo-induced gas-phase reactions.

The photocatalytic reactor cell assembly 100 may also include integrated control electronics to control the photon emitters, as well as drivers to drive the photon emitters. For example, LED drivers may be selected to operate at 50% or greater power load during operation of the photocatalytic reactor cell assembly 100, in order to improve driver efficiency. A system of several or many photocatalytic reactor cell assemblies 100 may share at least some common electronics, for example. In addition to operating the LED drivers at a 50% or greater power load during operation, another design consideration for efficient light delivery is to alter operating current to allow the LEDs to operate at maximum efficiency. In addition, the LEDS themselves may be chosen to have high photon efficiency in the same spectrum range (e.g., same visible spectrum range) as the photocatalyst. Diodes of different semiconductor materials are available with different specified electrical-to-photon energy efficiency. By choosing diodes with high photon efficiency in the same range as the photocatalyst, absorption of light by the catalyst can be increased.

The outer portion 132a of the light housing may be attached (e.g., via epoxy, adhesive, or mechanical fasteners) to the outer cell wall 102. The inner portion 132b of the light housing may be attached (e.g., via epoxy, adhesive, or mechanical fasteners) to the inner cell wall 110. Alternatively, the outer portion 132a and/or the inner portion 132b of the light housing may simply be positioned adjacent and in close proximity to the outer cell wall 102 and the inner cell wall 110, respectively, without being physically attached. As yet another alternative, a respective separation distance between (a) the outer portion 132a and/or the inner portion 132b of the light housing and (b) the outer cell wall 102 and the inner cell wall 110 may be chosen to realize desired lighting geometries. For example, either or both of the outer portion 132a and the inner portion 132b may have a small separation between itself and the outer cell wall 102 and the inner cell wall 110, respectively. As another example, either the outer portion 132a or the inner portion 132b may have a small separation to the outer cell wall 102 or the inner cell wall 110, while the other has a relatively larger separation. Separation 208 is illustrated as an example separation between the inner cell wall 110 and the inner portion 132b of the light housing. Alternatively or additionally, the outer portion 132a and/or the inner portion 132b of the light housing may include a frame or other structure upon which the circumferential array of photon emitters is mounted, and which may or may not be attached directly to the outer cell wall 102 and/or the inner cell wall 110. For example, such frame or other structure may be constructed of aluminum, stainless steel (SS316), or some other material. The outer portion 132a and/or the inner portion 132b of the light housing may have a single, unitary frame or structure or may have multiple frames or structures, such as one frame or structure for the outer portion 132a of the light housing and another frame or structure for the inner portion 132b of the light housing. In some embodiments, the mounting frame(s) or structure(s) for the circumferential array(s) of photon emitters may serve as cooling structures, in the form of cooling jackets, heat sinks, or other heat-dissipation mechanisms.

The embodiment illustrated in FIGS. 1-4 includes a cooling structure in the form of an outer cooling block 134 and an inner cooling block 138. The outer cooling block 134 is associated with the outer portion 132a of the light housing, while the inner cooling block 138 is associated with the inner portion 132b of the light housing. As shown, the outer cooling block 134 has a plurality of outer coolant passages 136, and the inner cooling block 138 has a plurality of inner coolant passages 140. While multiple coolant passages are illustrated in the examples of FIGS. 1-4, the outer cooling block 134 and/or the inner cooling block 138 may alternatively or additionally include a hollow, walled reservoir through which cooling fluid is circulated throughout its entirety or a portion thereof. For example, the outer cooling block 134 and/or the inner cooling block 138 may comprise walls (e.g., walls made of aluminum, which may be a cost-effective embodiment) defining a receptacle through which the cooling fluid is passed at a predetermined flow rate. In one example embodiment, the outer cooling block 134 and/or the inner cooling block 138 simply acts as a heat sink and does not utilize cooling fluid. In the case of LEDs being used as photon emitters, the cooling structure may maintain a surface on which the photon emitters are mounted at a temperature not exceeding 150 degrees Celsius, for example.

Generally, the outer portion 132a of the light housing may comprise an outer cooling block 134 and the inner portion 132b of the light housing may comprise an inner cooling block 138. The outer cooling block 134 and/or the inner cooling block 138 may be configured to assist in cooling the photon emitters and/or associated electronics, such as LED drivers. For example, the circumferential array of photon emitters may include a plurality of LEDs (on LED boards) mounted on at least one of the walls (e.g., aluminum walls) of the cooling block(s) 134 and/or 138, so that cooling fluid passing through each cooling block's coolant passage(s) and/or receptacle(s) assists in cooling the plurality of LED boards. Coolant may be introduced to and removed from the cooling block(s) 134 and/or 138 via one or more coolant lines interfaced with the outer coolant passages 136 and/or the inner coolant passages 140. Such coolant lines (not illustrated) may recirculate/recycle coolant (after appropriate heat removal or dissipation) and/or may introduce new coolant and remove old coolant, with no recirculation.

The cooling fluid utilized in the outer cooling block 135 and/or the inner cooling block 138 may be chosen to have a predetermined heat capacity. The cooling fluid (or coolant) may be selected from the following non-exhaustive list, for example: ammonia, synthetic hydrocarbons of aromatic chemistry (i.e., diethyl benzene [DEB], dibenzyl toluene, diaryl alkyl, partially hydrogenated terphenyl), silicate-esters, aliphatic hydrocarbons of paraffinic and iso-paraffinic type, dimethyl- and methyl phenyl-poly (siloxane), fluorinated compounds such as perfluorocarbons (i.e., FC-72, FC-77) hydrofluoroethers (HFE) and perfluorocarbon ethers (PFE), ethylene glycol, propylene glycol, methanol/water, ethanol/water, calcium chloride solution (e.g., 29% by wt.), aqueous solutions of potassium formate and acetate salts, and liquid metals (e.g., Ga—In—Sn).

### B. Endcap Fittings, Seals, Tension Rods, Gas Inlets, and Gas Outlets

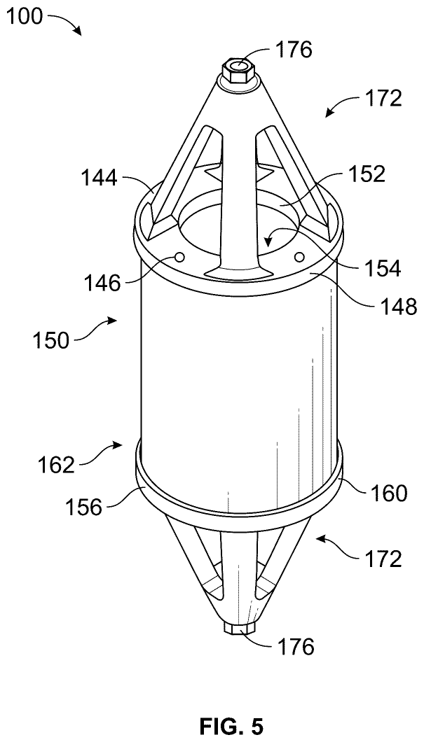

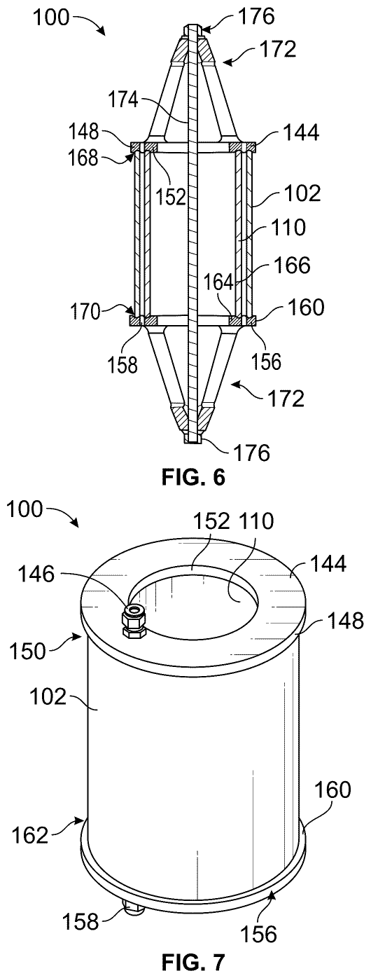

FIG. 5 is an isometric diagram illustrating the photocatalytic reactor cell assembly 100, according to an example embodiment. FIG. 6 is a vertical cross-sectional diagram illustrating the photocatalytic reactor cell assembly, according to an example embodiment. FIGS. 5 and 6 utilize the same reference numerals as in FIGS. 1-4 to refer to the same or similar features and/or components. Either or both of FIGS. 5 and 6 may omit some features and/or components from what is shown in FIGS. 1-4 (or each other), as appropriate, to permit better illustration and comprehension. For example, FIGS. 5 and 6 omit at least the outer cooling block 134, inner cooling block 138, details of the outer portion 132a and inner portion 132b of the light housing, photocatalyst packed bed 126, and porous base filter 130. FIGS. 5 and 6 are presented primarily to illustrate top and bottom endcap fittings of the photocatalytic reactor cell assembly 100, along with various features and components and features associated with the top and bottom endcap fittings.

As shown, the photocatalytic reactor cell assembly 100 includes a top compression endcap fitting 144 having an annular shape. The top compression endcap fitting 144 includes one or more (e.g., four) reactant gas inlets 146 for receiving a continuous flow of input gaseous reactant feedstock, which may include one or more constituent reactant gases. The top compression endcap fitting 144 may have a first outer circumferential flange 148 to fit around a top portion 150 of the outer cell wall 102, a first inner circumferential flange 152 to fit inside or outside a top portion 154 of the inner cell wall 110, or both the first outer circumferential flange 148 and first inner circumferential flange 152. While the above discussion and FIGS. 5 and 6 illustrate a cylindrical (annular) shape for the top compression endcap fitting 144, a circular shape may alternatively be used. As yet another alternative, non-cylindrical (non-annular) shapes may be suitable for a first tube 104 having a non-circular cross-section. For example, the top compression endcap fitting 144 may have a cross section that matched a regular polygonal cross section of the first tube 104. In addition, either or both of the first outer circumferential flange 148 and the first inner circumferential flange 152 may be omitted, in some embodiments.

Also as shown, the photocatalytic reactor cell assembly 100 includes a bottom compression endcap fitting 156 having an annular shape. The bottom compression endcap fitting 156 has one or more (e.g., four) product gas outlets 158 for outputting a continuous flow of gaseous product, which may include one or more constituent product gases. The bottom compression endcap fitting 156 has a second outer circumferential flange 160 to fit around a bottom portion 162 of the outer cell wall 102, a second inner circumferential flange 164 to fit inside or outside a bottom portion 166 of the inner cell wall 110, or both the second outer circumferential flange 160 and the second inner circumferential flange 164. While the above discussion and FIGS. 5 and 6 illustrate a cylindrical (annular) shape for the bottom compression endcap fitting 156, a circular shape may alternatively be used. As yet another alternative, non-cylindrical (non-annular) shapes may be suitable for a first tube 104 having a non-circular cross-section. For example, the bottom compression endcap fitting 156 may have a cross section that matched a regular polygonal cross section of the first tube 104. In addition, either or both of the second outer circumferential flange 160 and the second inner circumferential flange 164 may be omitted, in some embodiments.

The top compression endcap fitting 144 and the bottom compression endcap fitting 156 may be constructed of stainless steel (SS316), an austenitic nickel-chromium-based alloy, a nickel-chromium-iron-molybdenum alloy, or aluminum, for example. The top compression endcap fitting 144 and the bottom compression endcap fitting 156 alternatively or additionally may be constructed of other materials, such as those having a low coefficient of thermal expansion. Moreover, a portion (i.e., an inside-facing portion) of at least one of the top compression endcap fitting 144 and the bottom compression endcap fitting 156 facing the photocatalyst packed bed 126 may be polished to reflect emitted photons into the photocatalyst packed bed 126. Alternatively, a reflective coating (not shown) may be deposited or adhered to the top compression endcap fitting 144 and/or the bottom compression endcap fitting 156 facing the photocatalyst packed bed 126 to accomplish a similar purpose.

The top compression endcap fitting 144 and the bottom compression endcap fitting 156 respectively form a top seal 168 and a bottom seal 170 with the outer cell wall 102 and the inner cell wall 110. Either or both of the top seal 168 and the bottom seal 170 may be formed via pressure, such as by a compression force applied to a top surface of the top compression endcap fitting 144 and/or a compression force applied to a bottom surface of the bottom compression endcap fitting 156. Such a compression force presses the top and bottom compression endcap fittings 144 and 156 toward each other, vertically sandwiching or squeezing the outer cell wall 102 and the inner cell wall 110 when the photocatalytic reactor cell is oriented vertically (perpendicular to the ground). The top seal 168 and/or the bottom seal 170 may further include one or more gaskets or O-rings, such as an elastomeric gasket and/or O-ring, to create a relatively gas-tight (i.e., gas-impermeable) seal (e.g., a gasket face seal and/or an O-ring seal) between the top compression endcap fitting 144 and/or the bottom compression endcap fitting 156 and the outer cell wall 102 and/or the inner cell wall 110. A combination of gaskets and O-rings may be used to create gas-tight seals, in some embodiments. In some embodiments, the outer cell wall 102 and the inner cell wall 110 may be of different heights (lengths) to accommodate sealing with a gasket as opposed to an O-ring. For example, the inner cell wall 102 may be longer than the outer cell wall 110 to assist in coupling with the top compression endcap fitting 144 and the bottom compression endcap fitting 156. In such a case, it may be beneficial to use a gasket face seal for the inner cell wall 110 and an O-ring seal for the outer cell wall 102. The top seal 168 and/or the bottom seal 170 may include a gasket and/or O-ring located at an end/edge of the outer cell wall 102 or inner cell wall 110 or along a side of the inner cell wall 102 or inner cell wall 110, depending on the configuration of the top compression endcap fitting 144 and/or the bottom compression endcap fitting 156. In other embodiments, no gaskets or O-rings may be necessary, with adequate seals being created through compression force(s). Additionally or alternatively, the top and bottom compression endcap fittings 144 and 156 and/or the first tube 104 and second tube 112 may be constructed of material(s), such as certain plastics, elastomers, or other polymers, that promote a seal when interfaced.

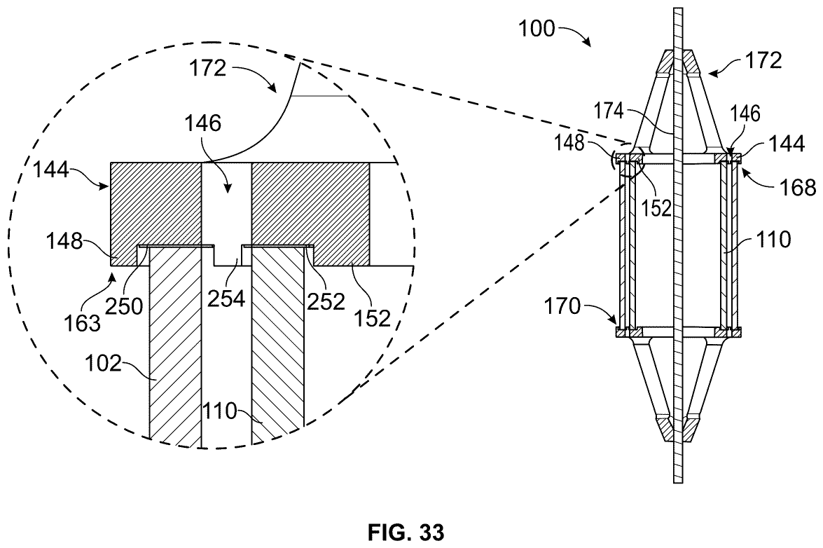

FIGS. 33-35 illustrate further details regarding the top seal 168 and bottom seal 170, according to several non-limiting embodiments. Each of FIGS. 33-35 includes reference numerals corresponding those shown in FIGS. 5 and 6; the description of components referenced by those reference numerals is incorporated by reference with respect to FIGS. 33-35 and will not be repeated here.

FIG. 33 illustrates detail of a top seal 168 for a photocatalytic reactor cell assembly 100 according to an example embodiment. As shown, the top seal 168 is formed by the top compression endcap fitting 144 being compressed against the outer cell wall 102 and the inner cell wall 110, such as via the tension rod 174. An outer gasket 250 is positioned in a first recess of the top compression endcap fitting 144 between the first outer circumferential flange 148 and a gasket shoulder 254, both of which are annular to match the general shape of the top compression endcap fitting 144. An inner gasket 252 is positioned in a second recess between the gasket shoulder 254 and the first inner circumferential flange 152. The compressive force applied to the top compression endcap fitting 144 against the outer cell wall 102 and the inner cell wall 110 forms the top seal 168 at the outer gasket 250 and inner gasket 252. A similar arrangement (or others, as described below and/or elsewhere) may be provided to realize the bottom seal 170.

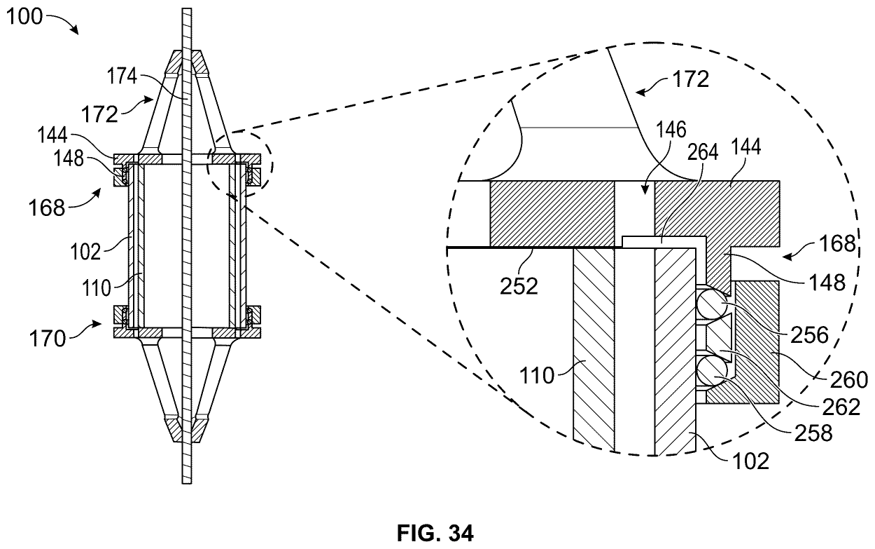

FIG. 34 illustrates detail of a top seal 168 for a photocatalytic reactor cell assembly 100 according to another example embodiment. As shown, the top seal 168 is formed differently for the inner cell wall 110 and the outer cell wall 102. For the inner cell wall 110, the top seal 168 is formed by the top compression endcap fitting 144 being compressed against the inner cell wall 110, such as via the tension rod 174. An inner gasket 252 (which could simply be a gasket material, such as a coating applied) is positioned on the top compression endcap fitting 144 (and/or to the top edge of the inner cell wall 110) at least where the top compression endcap fitting 144 interfaces with the inner cell wall 110. A compressive force applied to the top compression endcap fitting 144 against the inner cell wall 110 forms the top seal 168 at the inner gasket 252. A similar arrangement (or others, as described below and/or elsewhere) may be provided to realize at least a portion of the bottom seal 170.

For the outer cell wall 102, the top seal 168 is formed by a first outer upper O-ring 256 and a second outer upper O-ring 258 each positioned between the outer cell wall 102 and an annular outer O-ring compression sleeve 260. An outer O-ring compression sleeve wedge 262 (trapezoidal-shaped) is also positioned between the outer cell wall 102 and an annular O-ring compression sleeve 260 and separates the first outer upper O-ring 256 from the second outer upper O-ring 258, as illustrated. The outer O-ring compression sleeve 260 has a trapezoidal/tapered lip to apply a compressive force to the first outer upper O-ring 256 and the second outer upper O-ring 258 to form a substantially gas-tight seal where the O-rings 256 and 258 contact the outer cell wall 102. The outer O-ring compression sleeve 260 may have a tightening mechanism (e.g., a ratchet or a compression sleeve fastener 266) and/or may utilize tapered surfaces (i.e., other than normal to the surface of the outer cell wall 102) forming a trapezoidal compression chamber for the O-rings 256 and 258) to apply a force to the O-rings 256 and 258 as the outer O-ring compression sleeve 260 is moved toward the top compression endcap fitting 144. In other words, the O-rings 256 and 256 may deform slightly toward the outer cell wall 102 as the tapered surfaces on the first outer circumferential flange 148, the outer O-ring compression sleeve 260, and the outer O-ring compression sleeve wedge 262 are moved closer to one another. While two O-rings are shown, in some embodiments, the outer portion of the top seal 168 may utilize a single O-ring, three O-rings, or other numbers of O-rings or other sealing members. In the example shown, a void 264 is provided to prevent the outer cell from contacting the top compression endcap fitting 144, which allows the top seal 168 at the inner cell wall 110 to bear all or substantially all of the compressive load imparted between the tope compression endcap fitting 144 and the inner cell wall 110, to better form the seal with the inner gasket 252. The void 265 also lessens the need for tight manufacturing tolerances that would otherwise be required to seal two concentric faces using gaskets (i.e., face seals). A similar arrangement (or others, as described below and/or elsewhere) may be provided to realize at least a portion of the bottom seal 170.

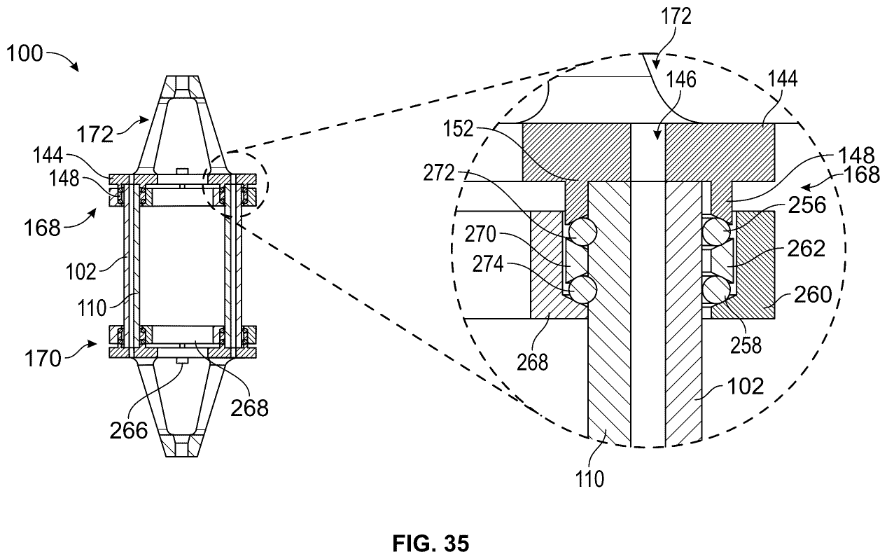

FIG. 35 illustrates detail of a top seal 168 for a photocatalytic reactor cell assembly 100 according to yet another example embodiment. As shown, the top seal 168 is formed using O-rings and outer and inner O-ring compression sleeves. The outer portion of the top seal 168 is similar or identical to as was described with respect to FIG. 34, except that the void 264 may or may not be included. The inner portion of the top seal 18 is formed by a first inner upper O-ring 272 and a second inner upper O-ring 274, each positioned between the inner cell wall 110 and an annular inner O-ring compression sleeve 268. An inner O-ring compression sleeve wedge 270 (trapezoidal-shaped) is also positioned between the inner cell wall 110 and an annular O-ring compression sleeve 270 and separates the first inner upper O-ring 272 from the second outer upper O-ring 274, as illustrated. The inner O-ring compression sleeve 268 has a trapezoidal/tapered lip to apply a compressive force to the first inner upper O-ring 272 and the second inner upper O-ring 274 to form a substantially gas-tight seal where the O-rings 272 and 274 contact the inner cell wall 110. The inner O-ring compression sleeve 268 may have a tightening mechanism (e.g., a ratchet or a compression sleeve fastener 266 to draw the inner O-ring compression sleeve 268 closer to the top compression endcap fitting 144) and/or may utilize tapered surfaces (i.e., other than normal to the surface of the inner cell wall 110) forming a trapezoidal compression chamber for the O-rings 272 and 274) to apply a force to the O-rings 272 and 274 as the inner O-ring compression sleeve 268 is moved toward the top compression endcap fitting 144. In other words, the O-rings 272 and 274 may deform slightly toward the inner cell wall 110 as the tapered surfaces on the first inner circumferential flange 152, the inner O-ring compression sleeve 268, and the inner O-ring compression sleeve wedge 270 are moved closer to one another. While two O-rings are shown, in some embodiments, the inner portion of the top seal 168 may utilize a single O-ring, three O-rings, or other numbers of O-rings or other sealing members. A similar arrangement (or others, as described below and/or elsewhere) may be provided to realize at least a portion of the bottom seal 170.

In the embodiments of FIGS. 5 and 6, the photocatalytic reactor cell assembly 100 further includes at least one tension rod 174 for imparting a compressive force to the top compression endcap fitting 144 and/or the bottom compression endcap fitting 156. For example, as best illustrated in FIG. 6, the tension rod 174 is coupled to both the top compression endcap fitting 144 and the bottom compression endcap fitting 156 to exert a compression force sufficient to cause the top seal 168 and the bottom seal 170 to be formed. The tension rod 174 is arranged to be co-linear with the vertical axis 118 about which the outer cell wall 102 and the inner cell wall 110 are concentrically arranged. Where more than one tension rod 174 provides the compression force, a plurality of such tension rods 174 may each be spaced a common distance from and around the vertical axis 118 relative to one another, to apply the compression force relatively evenly around the circumference or perimeter of the top compression endcap fitting 144 and/or the bottom compression endcap fitting 156. The tension rod(s) 174 may be located inside and/or outside the outer cell wall 102, the inner cell wall 110, and/or the light housing. The tension rod(s) 174 may be constructed of stainless steel (SS316), an austenitic nickel-chromium-based alloy, a nickel-chromium-iron-molybdenum alloy, or aluminum, for example. The tension rod(s) 174 alternatively or additionally may be constructed of another material. In a further embodiment, the tension rod(s) 174 may serve as a mounting structure for mounting the photocatalytic reactor cell 100 to another structure, such as a multi-cell frame that forms part of a larger reactor system. In some embodiments, the inner portion 132b and/or the outer portion 132a of the light housing fastens to the tension rod.

The tension rod(s) 174 may include threads cooperating with at least one threaded fastener 176 to facilitate tightening of the top compression endcap fitting 144 and/or the bottom compression endcap fitting 156 onto the outer cell wall 102 and the inner cell wall 110. The top compression endcap fitting 144 and/or the bottom compression endcap fitting 156 may each include a support 172 through which the tension rod 174 exerts the compression force. The support(s) 172 may be threaded or non-threaded to interact with the tension rod(s) 174 and/or with threaded fastener(s) 176. As an alternative to threads, springs, clamps, air pressure, and/or other mechanisms may be used to apply the compression force. The support(s) 172 may be constructed of stainless steel (SS316), an austenitic nickel-chromium-based alloy, a nickel-chromium-iron-molybdenum alloy, or aluminum, for example. The support(s) 172 alternatively or additionally may be constructed of another material. In the example embodiments shown in FIGS. 5 and 6, the support 172 generally has a conical shape, with the top compression endcap fitting 144 and the bottom compression endcap fitting 156 serving as a respective base for each of the conical supports 172 and the tension rod tightening on to the respective apex of each of the conical supports 172. Alternatively, the support(s) 172 may have other shapes. In yet other embodiments, the tension rod 172 physically interfaces directly with the top compression endcap fitting 144 and/or the bottom compression endcap fitting 156, as may be the case for a top compression endcap fitting 144 and/or bottom compression endcap fitting 156 having a disk shape (instead of an annulus shape) or other shape without a center void. As mentioned, a plurality of tension rods 174 may be coupled to each of the top compression endcap fitting 144 and the bottom compression endcap fitting 156 to exert a collective compression force sufficient to cause the top seal and the bottom seal to be formed. Potential advantages imparted by the use of one or more tension rods 174 include: (a) little to no interference with photons, thus improving overall efficiency of the photoreactor, (b) less exposure to high temperatures compared to other sealing mechanisms, thereby limiting thermal expansion, (c) improved force distribution on the sealing surfaces compared to a multi-bolt flange system, and (d) concentrated compression force between the concentric quartz tubes to limit deformation of the compression end caps without the use of hardware that penetrates the catalyst bed, which accordingly limits potential energy losses from the catalyst to the hardware that would otherwise penetrate the catalyst bed, among others.

Referring back to FIG. 4, when the photocatalytic reactor cell assembly 100 is oriented vertically (perpendicular to the ground) with respect to a gravitational force (not shown, but assumed to originate from the bottom of FIG. 4), the porous base filter 130 is preferably located at an underside (i.e., bottom) of the photocatalyst packed bed 126 closer to the bottom compression endcap fitting 156 than to the top compression endcap fitting 144. The photocatalyst packed bed 126 is positioned vertically in a middle portion 122 of the annular volume 120. The upper portion 124 of the annular volume 120 closest to the top compression endcap fitting 144 is devoid of the photocatalyst packed bed 126 to provide the sufficient headspace 128 for reactant gas mixing. The emission (by the plurality of photon emitters 142a and 142b) of photons incident on the photocatalyst packed bed 126 activates continuous photo-induced gas-phase reactions as at least one gaseous reactant introduced via the gas inlet 146 flows through the photocatalyst packed bed 126 and at least one resultant product gas exits via the gas outlet 158.

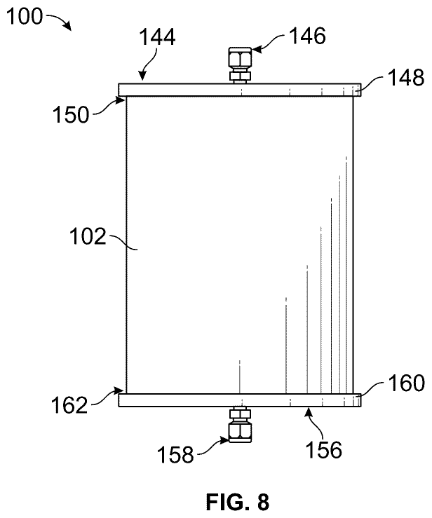

FIG. 7 is an isometric diagram and FIG. 8 is an elevational diagram illustrating the photocatalytic reactor cell assembly 100, according to another example embodiment. FIGS. 7 and 8 utilize the same reference numerals as in FIGS. 1-6 to refer to the same or similar features and/or components. Either or both of FIGS. 7 and 8 may omit some features and/or components from what is shown in FIGS. 1-6 (or each other), as appropriate, to permit better illustration and comprehension. For example, FIGS. 7 and 8 omit (but the described example embodiment may include) at least the outer cooling block 134, inner cooling block 138, details of the outer portion 132a and inner portion 132b of the light housing, photocatalyst packed bed 126, and porous base filter 130. FIGS. 7 and 8 are presented primarily to illustrate a variation (i.e., without supports 172 and tension rod 174) of the top and bottom endcap fittings 144 and 156 of the photocatalytic reactor cell assembly 100 shown in FIGS. 5 and 6. As such, the photocatalytic reactor cell assembly 100 of FIGS. 7 and 8 is of simpler construction than the photocatalytic reactor cell assembly 100 of FIGS. 5 and 6.

As shown in FIGS. 7 and 8, the photocatalytic reactor cell assembly 100 includes an outer cell wall 102 and an inner cell wall 110 on which a top compression endcap fitting 144 and a bottom compression endcap fitting 156 are mounted on respective top and bottom portions of the outer cell wall 102 and the inner cell wall 110. The top compression endcap fitting 144 includes a reactant gas inlet 146, a first outer circumferential flange 148 to fit around the top portion 150 of the outer cell wall 102, and a first inner circumferential flange 152 to fit inside the top portion of the inner cell wall 110. Similarly, the bottom compression endcap fitting 156 includes a product gas outlet 158, a second outer circumferential flange 160 to fit around the bottom portion 162 of the outer cell wall 102, and a second inner circumferential flange (not illustrated) to fit inside the bottom portion of the inner cell wall 110. In some example embodiments, the top compression endcap fitting 144 and the bottom compression endcap fitting 156 are press-fit onto the outer cell wall 102 and an inner cell wall 110. Alternatively, the top compression endcap fitting 144 and the bottom compression endcap fitting 156 are press-fit onto a light housing surrounding at least a portion (e.g., the outside and the inside, respectively) of the outer cell wall 102 and an inner cell wall 110. Other attachment configurations and/or mechanisms may also be used.

C. Reactor Cell Assembly with Light Housing Having Outer and Inner IR Lamps

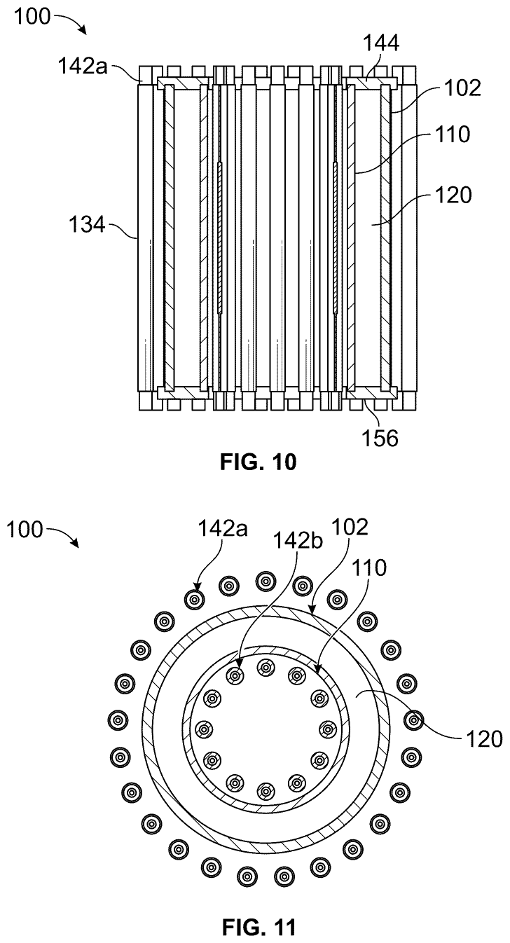

FIG. 9 is an isometric diagram illustrating a reactor cell assembly 100, according to an example embodiment. FIG. 10 is a vertical cross-sectional diagram illustrating a reactor cell assembly 100, according to an example embodiment. FIG. 11 is a horizontal cross-sectional diagram illustrating a reactor cell assembly 100, according to an example embodiment. FIGS. 9-11 may omit some features and/or components from what is shown in various of FIGS. 1-8 (or each other), as appropriate, to permit better illustration and comprehension. For example, FIGS. 9-11 omit (but the described example embodiments may include) at least the outer cooling block 134, inner cooling block 138, details of the outer portion 132a and/or inner portion 132b of the light housing, photocatalyst packed bed 126, porous base filter 130, reactant gas inlet 146, and product gas outlet 158. FIGS. 9-11 are presented primarily to illustrate a variation of the photocatalytic reactor cell 100 in which IR lamps serve as photon emitters and/or heaters in the light housing.

As shown in FIGS. 9-11, a reactor cell assembly 100 includes an outer cell wall 102 around which a plurality of photon emitters 142a, in the form of IR lamps, is circumferentially arranged, serving as an outer portion of a light housing. The reactor cell assembly 100 further includes an inner cell wall 110 inside of which a plurality of photon emitters 142b, in the form of IR lamps, is circumferentially arranged to serve as an inner portion of a light housing. A top compression endcap fitting 144 and a bottom compression endcap fitting 156 form respective top and bottom seals through which only gaseous reactant input(s) and gaseous product output(s) are intended to pass via respective reactant gas inlet(s) and product gas outlet(s), neither of which are illustrated in FIGS. 9-11.

In embodiments in which the reactor cell assembly 100 is a photocatalytic reactor cell assembly, the annular volume 120 between the outer cell wall 102 and the inner cell wall 110 may include a photocatalyst packed bed upon which emitted incident light (e.g., in the near-IR spectrum) from the pluralities of photon emitters 142a and 142b activates continuous photo-induced gas-phase reactions as at least one gaseous reactant flows through the photocatalyst packed bed to produce at least one resultant gaseous product. The IR lamps may additionally supply heat to the photocatalyst packed bed to further catalyze the reaction(s). In alternative embodiments in which the reactor cell assembly 100 is a thermal catalytic reactor cell (with no photocatalyst in the packed catalyst bed), the IR lamps in the plurality of photon emitters 172a and/or 172b may simply provide infrared radiative heating to the catalyst bed. Since the IR lamps are located on both sides of the annular volume 120 between the outer cell wall 102 and the inner cell wall 110, radiative heating is distributed more evenly and directly into the catalyst packed bed compared to conventional thermal reactors.

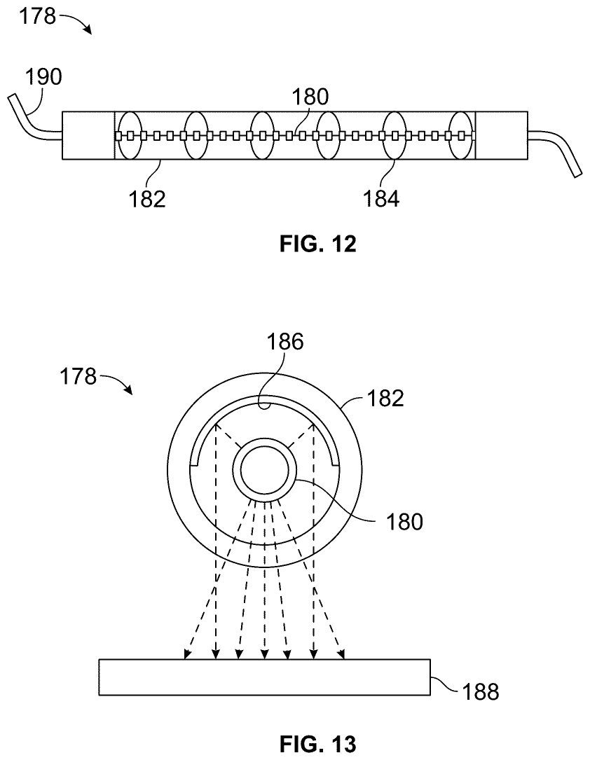

FIGS. 12 and 13 are, respectively, an elevational diagram and a horizontal cross-sectional schematic diagram illustrating a single IR lamp 178 that may be used as a photon emitter, such as in the plurality of photon emitters 172a and/or 172b, according to an example embodiment. The lamp 178 may additionally or alternatively be used as a heating element for a photocatalytic reactor cell assembly or a thermal reactor cell assembly, according to example embodiments.

As shown in FIGS. 12 and 13, the IR lamp 178 includes a tungsten filament 180 in the center of a quartz envelope 182 that may have one or more support rings 184 circling the tungsten filament 180 on an inside circumference of the quartz envelope 182. A portion of an inside surface of the quartz envelope 182 is preferably coated with a reflective coating 186, such as a glazed ceramic coating, to direct generated infrared radiation toward a target 188 (e.g., a photocatalyst packed bed). For example, the reflective coating 186 may be on a surface of the IR lamp distal from the vertical axis 118 (see, e.g., FIG. 1.) in the case of the outer portion 142a of the light housing, or on a surface of the IR lamp proximal to the vertical axis 118, in the case of the inner portion 142b of the light housing. The reflective coating 186 is chosen to be stable at high temperatures, such as temperatures up to 1000 degrees Celsius or higher, for example. The amount of the inside surface of the quartz envelope 182 that is coated with the reflective coating 186 may depend on a number of factors, such as the diameter of the quartz envelope 182, the distance to the target 188, and the width of the target 188, for example. In one example embodiment, half (180-degrees) of the inner circumference of the quartz envelope 182 is coated with the reflective coating 186, as illustrated in FIG. 13. This may result, for example, in focused radiation being directed at a viewing angle of 120-degrees from the IR lamp 178. This focused radiation toward the target 188 provides higher efficiency compared to an IR lamp 178 in which the quartz envelope 182 does not include a reflective coating 186, since radiation that would otherwise be directed away from the target 188 is instead focused toward the target 188. One or more lead wires 190 can be used to supply current through the tungsten filament 180 to generate the desired infrared radiation.

Infrared radiation is electromagnetic radiation with wavelengths longer than those of visible light. For example, while the visible light spectrum may have wavelengths from about 380 nm to about 750 nm, infrared radiation may have wavelengths from about 750 nm to about 1 mm. Infrared radiation is emitted or absorbed by molecules when they change their rotational/vibrational movements. This absorption of radiation is commonly associated with an increase in temperature of the molecule. The maximum amount of radiation emitted by an ideal emitter (a black body) is proportional to the 4th power of its temperature:

$$E = σ ( {T}^{4} - {T}_{0}^{4} ) \qquad Equation 1$$

where σ is the Stefan-Boltzmann constant. The introduction of non-ideality in an emitter's ability to radiate energy requires the addition of a proportionality constant ε, known as emissivity, which is the ability of a body to emit infrared energy. Typical emissivity values range from 0.02 (e.g., for mirrors or polished gold) to as high as 0.95 (e.g., for oxidized surfaces and carbon).

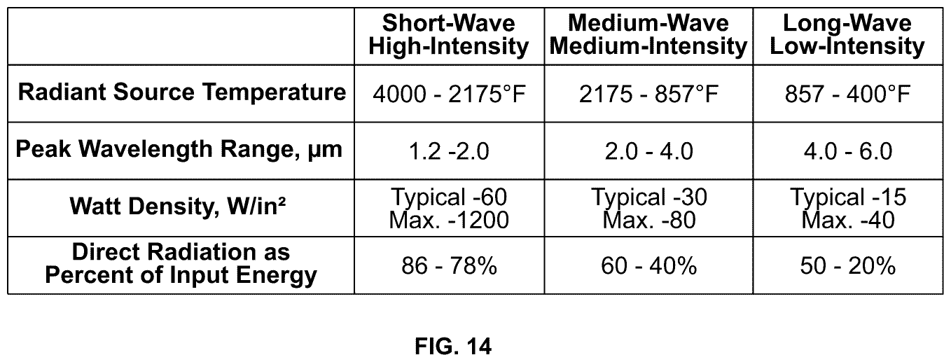

Infrared heating can be applied to a target by using an electrical infrared heater technology in which electric current is passed through a resistive filament such as tungsten or nichrome wire such that it glows and emits infrared radiation. The usable range of infrared radiation for industrial applications is from 760 μm to about 10,000 nm (10 μm) and is classified into three categories (short-wave, high-intensity; medium-wave, medium-intensity; and long-wave, long-intensity), as illustrated in the table 1400 shown in FIG. 14.

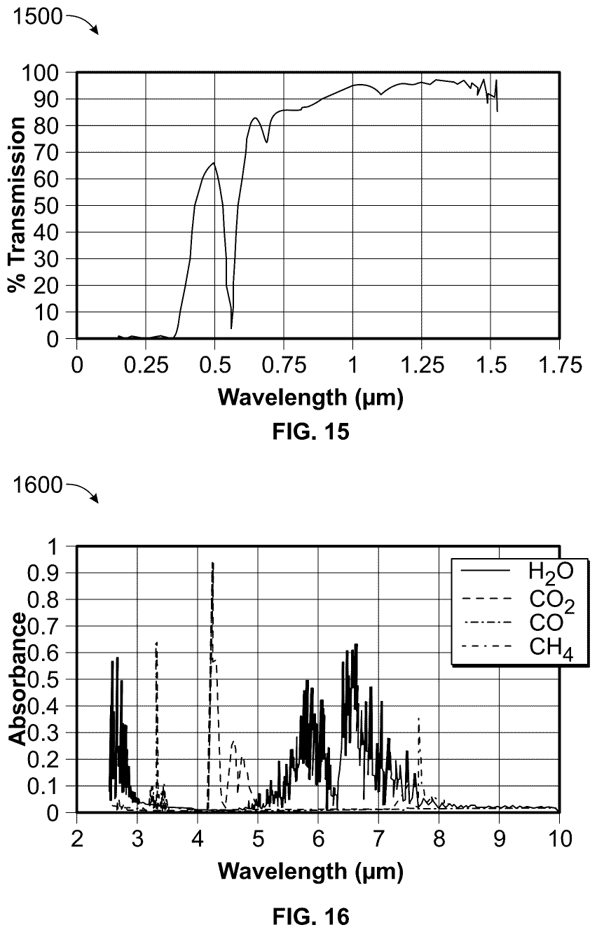

Various embodiments of the reactor cell assemblies disclosed herein utilize short-wave IR lamps (e.g., IR lamp 178) to impart heat to the catalyst bed contained in the reactor cell (i.e., in the annular volume between the outer cell wall and the inner cell wall). The IR lamps are provided in the light housing (which may be simply a circular grouping or bank of the IR lamps themselves) fabricated with IR reflective materials (e.g., the reflective coating 186) to contain substantially all of the emitted radiation within the reactor cell assembly. Short-wave IR lamps generate radiation with a peak wavelength of 1.25 μm from a filament (e.g., the tungsten filament 180) that is at a temperature of 2200° C. The quartz envelope 182 housing the tungsten filament 180 has excellent high temperature stability and transmits over 97% of the infrared radiation generated by the emitter (at 677° C.), as illustrated in the graph 1500 of FIG. 15. These same characteristics of quartz are also favorable for transmission through the outer wall and/or the inner wall of the reactor cell assembly, allowing for efficient absorption by the catalyst and the reactants.

The infrared-transmission characteristics of quartz help to overcome the limitations posed by the low thermal conductivity of quartz, making it a good candidate for construction of the outer wall and/or inner wall of the reactor assembly. In addition, infrared radiation (including near-IR radiation) is strongly absorbed by various gaseous species, such as reactant gases that might be utilized in the reactor cell assembly embodiments disclosed herein. FIG. 16 is a graph 1600 illustrating the IR absorption spectra for various gaseous species (water (steam), carbon dioxide, carbon monoxide, and methane). Therefore, while primary radiation may center around a peak wavelength of 1.25 μm, any reflected or scattered radiation may be in the range of about 2 μm to about 10 μm. As illustrated in FIG. 16, this higher-wavelength reflected or scattered radiation is likely to be absorbed by the reactant gases, resulting in efficient utilization of radiation by the reactor cell assembly, according to various example embodiments.

D. Reactor Cell Assembly with Light Housing Having Cooled Outer LED and Inner IR Lamps

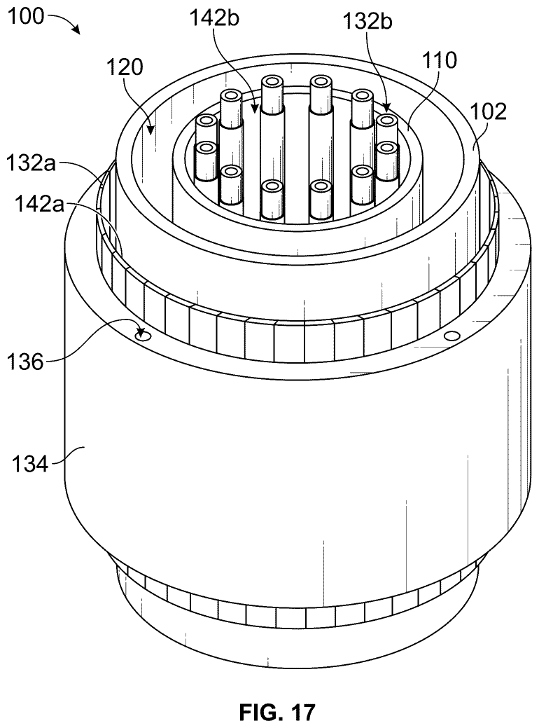

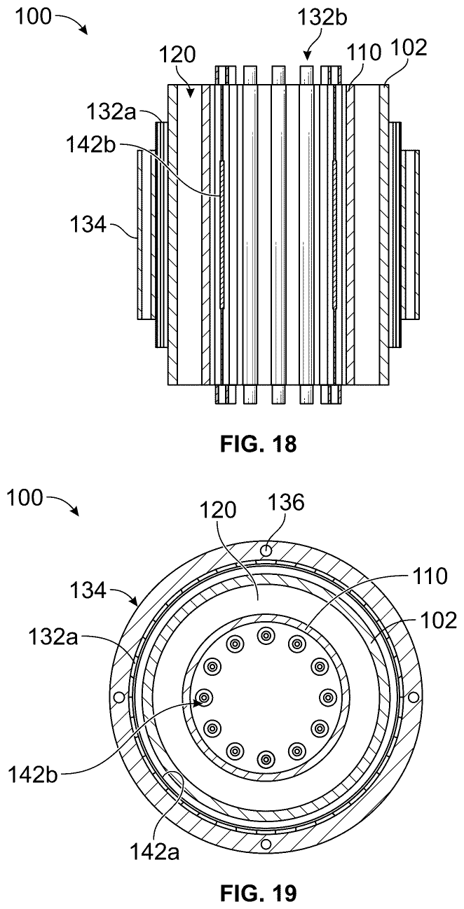

FIG. 17 is an isometric diagram illustrating a photocatalytic reactor cell assembly 100, according to an example embodiment. FIG. 18 is a vertical cross-sectional diagram illustrating a photocatalytic reactor cell assembly 100, according to an example embodiment. FIG. 19 is a horizontal cross-sectional diagram illustrating a photocatalytic reactor cell assembly 100, according to an example embodiment. FIGS. 17-19 may omit some features and/or components from what is shown in various of FIGS. 1-11 (or each other), as appropriate, to permit better illustration and comprehension. For example, FIGS. 17-19 omit (but the described example embodiments may include) at least the photocatalyst packed bed 126, porous base filter 130, reactant gas inlet 146, and product gas outlet 158. FIGS. 17-19 are presented primarily to illustrate a variation of the photocatalytic reactor cell 100 in which LEDs serve as photon emitters in an outer portion 132a of the light housing and IR lamps serve as photon emitters and/or heaters in an inner portion 132b of the light housing.

As shown in FIGS. 17-19, a reactor cell assembly 100 includes an outer cell wall 102 around which a plurality of photon emitters 142a, in the form of LEDs (e.g., thousands of LEDs each 1-5 mm across), is circumferentially arranged, serving as the outer portion 132a of the light housing. For example, the LEDs may be mounted on LED circuit boards or in other configurations, as is illustrated in FIGS. 1-4 and several other figures herein. The reactor cell assembly 100 further includes an inner cell wall 110 inside of which a plurality of photon emitters 142b, in the form of IR lamps, is circumferentially arranged to serve as the inner portion 132b of a light housing. A top compression endcap fitting and a bottom compression endcap fitting (neither of which is illustrated in FIGS. 17-19, but which may be similar to what is illustrated in FIGS. 5-8, for example) form respective top and bottom seals through which only gaseous reactant input(s) and gaseous product output(s) are intended to pass via respective reactant gas inlet(s) and product gas outlet(s), similar to as illustrated in FIGS. 5-8, for example.

In embodiments in which the reactor cell assembly 100 is a photocatalytic reactor cell assembly, the annular volume 120 between the outer cell wall 102 and the inner cell wall 110 may include a photocatalyst packed bed. Emitted incident light from the pluralities of photon emitters 142a and 142b (e.g., in the visible and the near-IR spectrums, respectively) activates continuous photo-induced gas-phase reactions as at least one gaseous reactant flows through the photocatalyst packed bed to produce at least one resultant gaseous product. The IR lamps may additionally or alternatively supply heat to the photocatalyst packed bed to further catalyze the reaction(s).

Also illustrated in FIGS. 17-19 is an outer cooling block 134 that includes a plurality of outer cooling passages 136. As described with reference to FIGS. 1-4, the outer cooling block 134 is associated with the outer portion 132a of the light housing. And while multiple coolant passages 136 are illustrated in the example of FIGS. 17-19, the outer cooling block 134 may alternatively or additionally include a hollow, walled reservoir through which cooling fluid is circulated throughout its entirety or a portion thereof. For example, the outer cooling block 134 may comprise aluminum walls defining a receptacle through which the cooling fluid is passed at a predetermined flow rate. In one example embodiment, the outer cooling block 134 simply acts as a heat sink and does not utilize cooling fluid. The cooling structure may maintain a surface on which the photon emitters are mounted at a temperature not exceeding 150 degrees Celsius, for example.

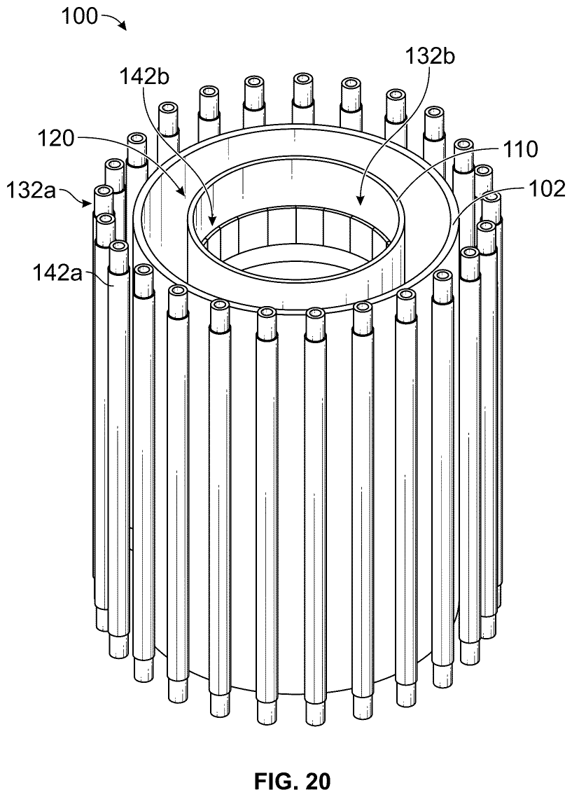

In addition to the outer cooling block 134, an inner cooling block (not shown) may be included to cool the photon emitters 142b (IR lamps) in the inner portion 132b of the light housing. For example, such an inner cooling block may have a structure and form factor similar to what is illustrated as inner cooling block 138 in FIGS. 20-22, described below, and may utilize any of a number of cooling methods, such as fluid cooling, forced-air cooling, and/or conductive cooling (e.g., via one or more heat sinks). And the cooling block need not be in the form of a solid block, per se, but may instead be implemented as two or more separate cooling structures, such as fans, cooling lines, or heat sinks.

E. Reactor Cell Assembly with Light Housing having Outer IR Lamps and Cooled Inner LEDs

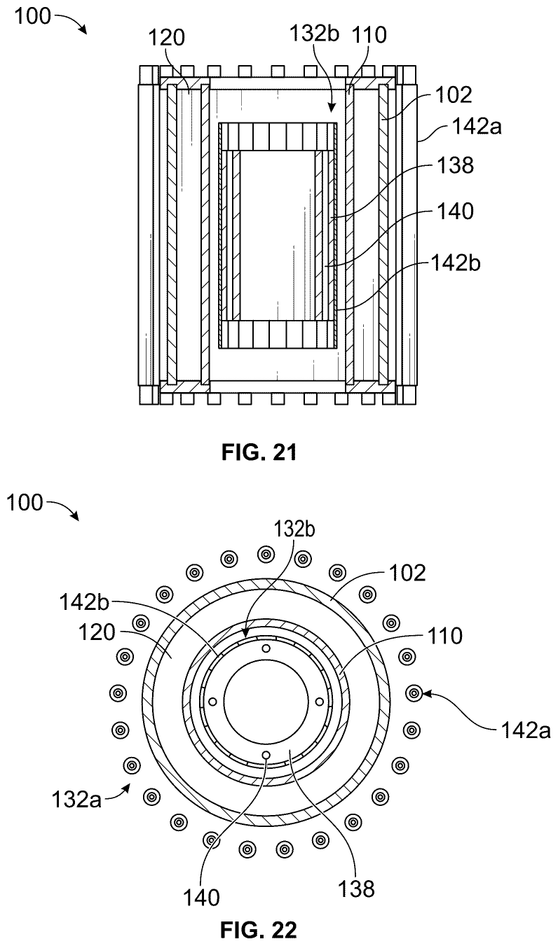

FIG. 20 is an isometric diagram illustrating a photocatalytic reactor cell assembly 100, according to an example embodiment. FIG. 21 is a vertical cross-sectional diagram illustrating a photocatalytic reactor cell assembly 100, according to an example embodiment. FIG. 22 is a horizontal cross-sectional diagram illustrating a photocatalytic reactor cell assembly 100, according to an example embodiment. FIGS. 20-22 may omit some features and/or components from what is shown in various of FIGS. 1-11 (or each other), as appropriate, to permit better illustration and comprehension. For example, FIGS. 20-22 omit (but the described example embodiments may include) at least the photocatalyst packed bed 126, porous base filter 130, reactant gas inlet 146, and product gas outlet 158. FIGS. 20-22 are presented primarily to illustrate a variation of the photocatalytic reactor cell 100 in which IR lamps serve as photon emitters and/or heaters in an outer portion 132a of the light housing and LEDs serve as photon emitters in an inner portion 132b of the light housing. As such, FIGS. 20-22 illustrate an example in which an outer portion of the light housing may serve as a heater to heat an annular volume to thereby increase the reaction rate of the photo-induced gas-phase reaction.

As shown in FIGS. 20-22, a reactor cell assembly 100 includes an outer cell wall 102 around which a plurality of photon emitters 142a, in the form of IR lamps, is circumferentially arranged, serving as the outer portion 132a of the light housing. The reactor cell assembly 100 further includes an inner cell wall 110 inside of which a plurality of photon emitters 142b, in the form of LEDs, is circumferentially arranged to serve as the inner portion 132b of a light housing. For example, the LEDs may be mounted on LED circuit boards or in other configurations, as is illustrated in FIGS. 1-4 and several other figures herein. A top compression endcap fitting and a bottom compression endcap fitting (neither of which is illustrated in FIGS. 20-22, but which may be similar to what is illustrated in FIGS. 5-8, for example) form respective top and bottom seals through which only gaseous reactant input(s) and gaseous product output(s) are intended to pass via respective reactant gas inlet(s) and product gas outlet(s), similar to as illustrated in FIGS. 5-8, for example.

In embodiments in which the reactor cell assembly 100 is a photocatalytic reactor cell assembly, the annular volume 120 between the outer cell wall 102 and the inner cell wall 110 may include a photocatalyst packed bed. Emitted incident light from the pluralities of photon emitters 142a and 142b (e.g., in the near-IR and the visible spectrums, respectively) activates continuous photo-induced gas-phase reactions as at least one gaseous reactant flows through the photocatalyst packed bed to produce at least one resultant gaseous product. The IR lamps may additionally or alternatively supply heat to the photocatalyst packed bed to further catalyze the reaction(s).

Also illustrated in FIGS. 20-22 is an inner cooling block 138 that includes a plurality of inner cooling passages 140. As described with reference to FIGS. 1-4, the inner cooling block 138 is associated with the inner portion 132b of the light housing. And while multiple coolant passages 140 are illustrated in the example of FIGS. 20-22, the inner cooling block 138 may alternatively or additionally include a hollow, walled reservoir through which cooling fluid is circulated throughout its entirety or a portion thereof. For example, the inner cooling block 138 may comprise aluminum walls defining a receptacle through which the cooling fluid is passed at a predetermined flow rate. In one example embodiment, the inner cooling block 138 simply acts as a heat sink and does not utilize cooling fluid. The cooling structure may maintain a surface on which the photon emitters are mounted at a temperature not exceeding 150 degrees Celsius, for example. Similarly, in addition to the inner cooling block 138, an outer cooling block (not shown) may be included to cool the photon emitters 142a (IR lamps) in the outer portion 132a of the light housing. For example, such an outer cooling block may have a structure and form factor similar to what is illustrated as outer cooling block 134 in FIGS. 17-19, described below, and may utilize any of a number of cooling methods, such as fluid cooling, forced-air cooling, and/or conductive cooling (e.g., via one or more heat sinks). And the cooling block need not be in the form of a solid block, per se, but may instead be implemented as two or more separate cooling structures, such as fans, cooling lines, or heat sinks.

F. Reactor Cell Assembly with Applied Heating

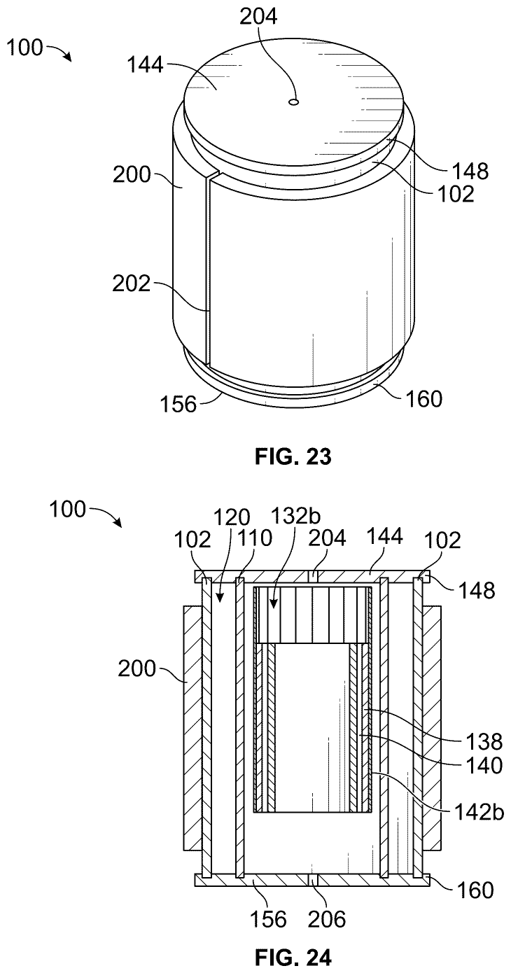

Some example embodiments of the photocatalytic reactor cell assembly 100 additionally or alternatively include a heater to apply heat to at least the annular volume 120, thereby increasing the reaction rate of the photo-induced gas-phase reactions. FIGS. 23-332 Illustrate examples of such heaters, including a band heater, an embedded annular heater, an embedded helical coil heater, and embedded IR heaters. Other types of heaters may be utilized in ways similar to as illustrated. For example, one or more cartridge heaters may be used as immersion heaters as a potentially efficient low-cost direct-immersion heater.

G. Reactor Cell having Outer Band Heater

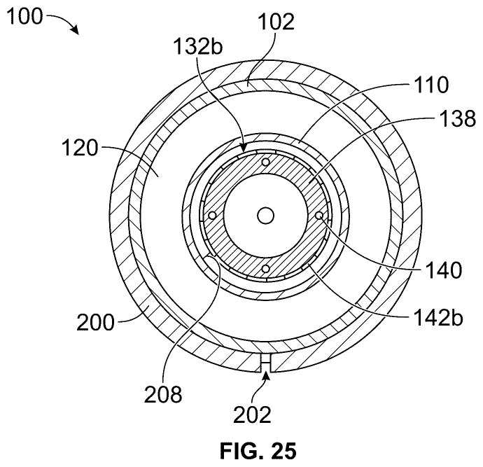

FIG. 23 is an isometric diagram illustrating a photocatalytic reactor cell assembly 100 with outer band heater 200, according to an example embodiment. FIG. 24 is a vertical cross-sectional diagram illustrating a photocatalytic reactor cell assembly 100 with outer band heater 200, according to an example embodiment. FIG. 25 is a horizontal cross-sectional diagram illustrating a photocatalytic reactor cell assembly 100 with outer band heater 200, according to an example embodiment. FIGS. 23-25 may omit some features and/or components from what is shown in various other figures described herein (or each other), as appropriate, to permit better illustration and comprehension. For example, FIGS. 23-25 omit (but the described example embodiments may include) at least the photocatalyst packed bed 126, porous base filter 130, reactant gas inlet 146, and product gas outlet 158. FIGS. 23-25 are presented primarily to illustrate a variation of the photocatalytic reactor cell assembly 100 in which an outer band heater 200 provides beneficial heating to portions of the photocatalytic reactor cell assembly 100, such as the photocatalyst packed bed 126 (not shown). The outer band heater 200 provides for direct contact with the outer cell wall 102 of the photocatalytic reactor cell assembly 100, allowing for direct conduction of heat along with radiative heat transfer, and thus minimizing heat losses.

The outer band heater 200 may take the form of a tube furnace heater, a ceramic fiber heater, or a heater coil wrapped around the outer cell wall 102. As shown in FIGS. 23-25, the outer band heater 200 wraps around the outer cell wall 102 so that a first edge of the outer band heater 200 is adjacent to an opposite edge of the outer band heater 200 at a seam 202. A small or non-existent seam 202 may contribute to consistent heating of the photocatalytic reactor cell assembly 100. Of course, a wider seam 202 or multiple seams 202 are also possible, and may provide other benefits, such as ease in assembly or manufacture. In some embodiments, the outer band heater 200 is flexible, so that assembly may include wrapping the band heater 200 end-to-end around the outer cell wall 102.

Also shown in FIGS. 23-25 are a top compression endcap fitting 144 with a first outer circumferential flange 148 and a bottom compression endcap fitting 156 with a second outer circumferential flange 160. The first and second outer circumferential flanges 148 and 160 help to form respective top and bottom seals with the outer cell wall 102 to prevent leakage of the gaseous reactants or products. Similar flanges or other sealing mechanisms, such as gaskets and/or O-rings, may be used with respect to the inner cell wall 110. Further details regarding the top and bottom seals may be found with reference to FIGS. 5 and 6, for example. One or more tension rods (not shown) may interface with a top compression socket 204 and a bottom compression socket 206, which may be threaded openings, for example, to assist in forming compression seals for the top compression endcap fitting 144 and the bottom compression endcap fitting 156. Other arrangements described elsewhere herein may alternatively be utilized. One or more reactant gas inlets (not shown) and product gas outlets (not shown) respectively provide reactant gas(es) to and remove product gas(es) from the annular volume 120 between the outer cell wall 102 and the inner cell wall 110.

In the example embodiment illustrated in FIGS. 23-25, the inner portion 132b of the light housing may be similar or identical to the inner portion 132b shown in FIGS. 1-4 and 20-22, having photon emitters 142b and an inner cooling block 138 with inner cooling passages 140. However, in contrast to the example embodiments of FIGS. 1-4 and 20-22, the light housing of FIGS. 23-25 does not include an outer portion 132a with photon emitters, and instead includes the band heater 200. As such, FIGS. 23-25 illustrate an example in which an outer portion of the light housing serves as a heater to heat an annular volume to thereby increase the reaction rate of the photo-induced gas-phase reaction.

H. Reactor Cell having Embedded Annular Heater

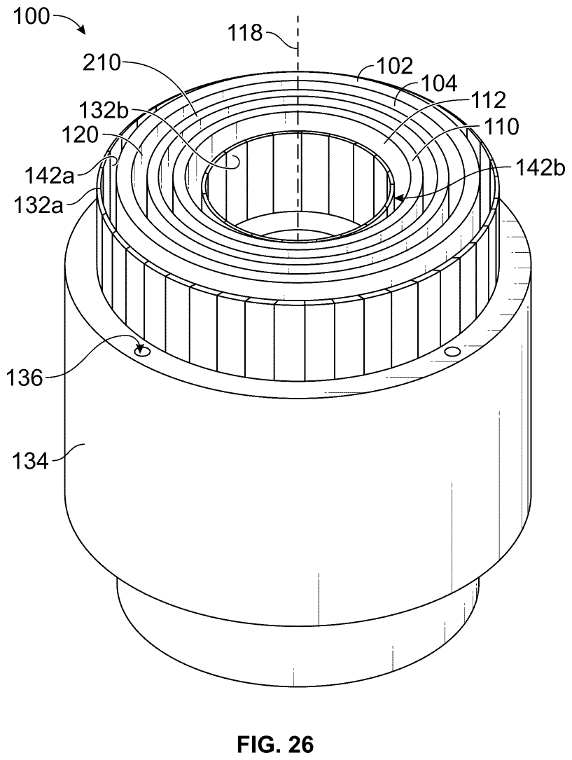

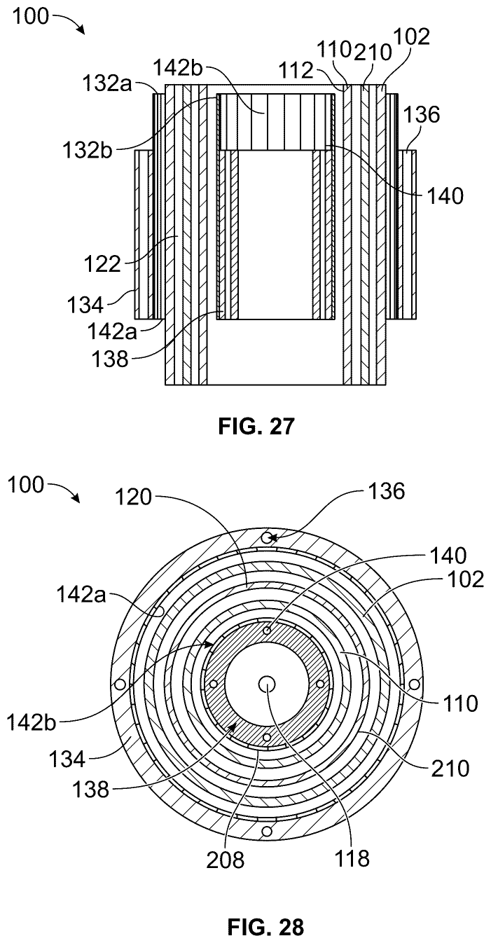

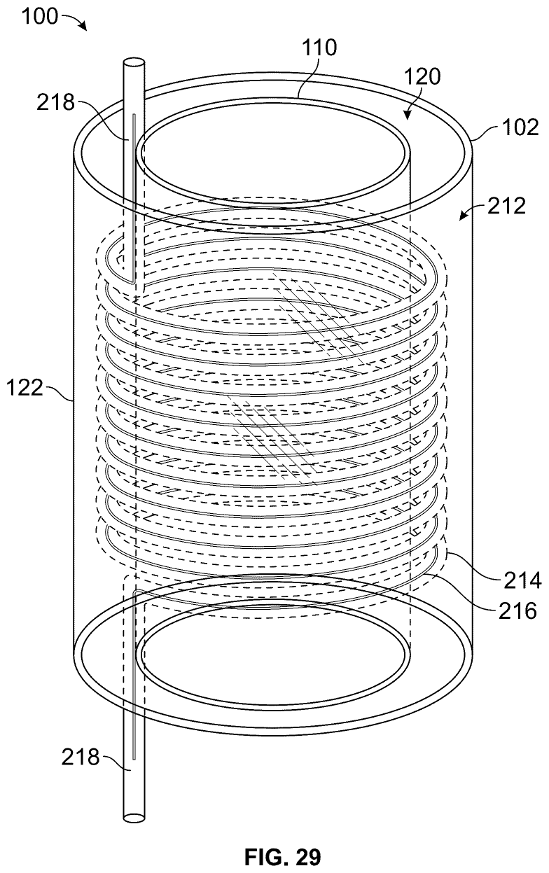

FIG. 26 is an isometric diagram illustrating a photocatalytic reactor cell assembly 100 with an annular heater 210, according to an example embodiment. FIG. 27 is a vertical cross-sectional diagram illustrating a photocatalytic reactor cell assembly 100 with an annular heater 210, according to an example embodiment. FIG. 28 is a horizontal cross-sectional diagram illustrating a photocatalytic reactor cell assembly 100 with an annular heater 210, according to an example embodiment. FIGS. 26-28 may omit some features and/or components from what is shown in various other figures described herein (or each other), as appropriate, to permit better illustration and comprehension. For example, FIGS. 26-28 omit (but the described example embodiments may include) at least the photocatalyst packed bed 126, porous base filter 130, reactant gas inlet 146, and product gas outlet 158. FIGS. 26-28 are presented primarily to illustrate a variation of the photocatalytic reactor cell assembly 100 in which an annular heater 210 embedded or immersed in the annular volume 120 between the outer cell wall 102 and the inner cell wall 110 provides beneficial heating to portions of the photocatalytic reactor cell assembly 100, such as the photocatalyst packed bed 126 (not shown). Use of such an embedded/immersed annular heater supplies energy directly to the catalyst bed in the annular region, which minimizes heat losses by removing multiple layers of materials between heat source and catalyst compared to external heaters.

With the exception of the annular heater 210, all components illustrated in FIGS. 26-28 are similar or identical to those illustrated in FIGS. 1-3 and are numbered accordingly. Further details regarding such components are described elsewhere herein. In example embodiments, the annular heater 210 may have a shape (e.g., cylindrical) similar to the first tube 104 and/or the second tube 112. The annular heater 210 may be a ceramic fiber heater, a substrate having resistive heating elements, or other annular-shaped heater, for example. In some embodiments, the mechanism for providing heat is less important that the shape of the annular heater 210. An annular heater 210 having a shape approximating the shape of the annular region 120 may advantageously apply consistent heating throughout the annular volume 120. A thicker annular heater 210 may have more thermal mass, but also presents a tradeoff in the form of less available space in the annular volume 120 for the photocatalyst packed bed 126. In the embodiment illustrated in FIGS. 26-28, the portion of the annular volume 120 occupied by the annular heater 210 is approximately one-third or less. Other portions may be appropriate for certain reactor cell geometries, such as for relatively thinner or relatively thicker annular volumes 120.

I. Reactor Cell having Embedded Helical Coil Heater

FIG. 29 is an isometric diagram illustrating a reactor cell assembly 100 with an embedded coil heater 212, according to an example embodiment. To simplify the illustration for better comprehension, many components have been omitted from FIG. 29, including the light housing (outer and inner portions), endcap fittings, gas inlets and outlets, catalyst bed (e.g., photocatalyst packed bed), porous base filter, cooling blocks, and any additional heaters besides the coil heater 212.

The reactor cell assembly 100 of FIG. 29 includes an outer cell wall 102 arranged concentrically around an inner cell wall 110 to define an annular volume 120 between the outer cell wall 102 and the inner cell wall 110. As illustrated in FIG. 4, the annular volume 120 includes a middle portion 122 having a photocatalyst packed bed 126 for catalyzing photo-induced gas-phase reactions. To increase the reaction rate of the photo-induced gas-phase reactions, the embedded coil heater 212 may be embedded or immersed in some or all of the middle portion 122 of the annular volume 120.

In an example embodiment, the coil heater 212 may be implemented as a helical tube 214 having a resistive heater wire 216 (e.g., a continuous filament, potentially including a hot section near the catalyst bed and cold sections away from the catalyst bed) disposed therein. For example, the coil heater 212 may be an IR coil lamp having a helical tube 214 made of quartz with a tungsten filament serving as the resistive heater wire 216, in a configuration similar to as shown in FIG. 12, but shaped as a helix to generally conform to the shape of the annular volume 120. One or more interface tubes 218 (e.g., made of quartz) may interface with first and second ends of the helical tube 214 to encase electrical leads (not shown) to drive current through the resistive heater wire 216. The embedded coil heater 212 implemented as a helical quartz IR coil lamp can provide both infrared and radiative heating to the photocatalyst packed bed 126 to increase the reaction rate of photo-induced gas-phase reactions, according to some embodiments. In some embodiments, use of such a coil heater allows for higher watt density at higher temperatures for highly endothermic reactions.

J. Reactor Cell having Embedded IR Heaters

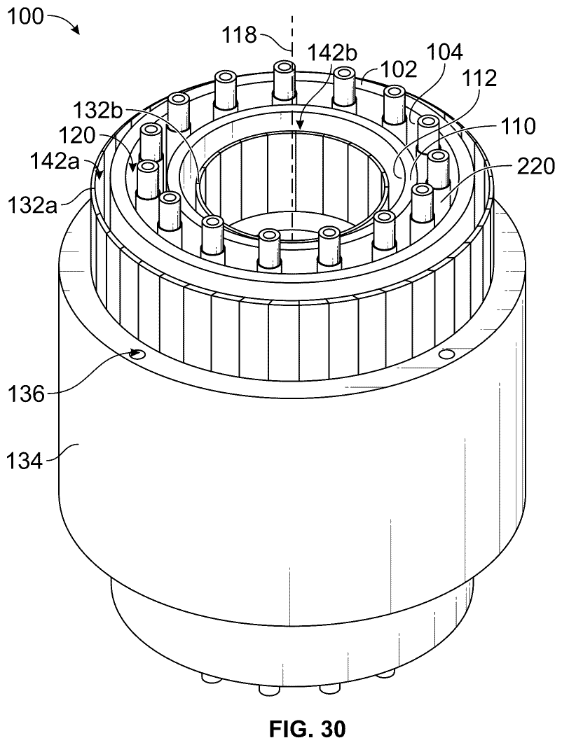

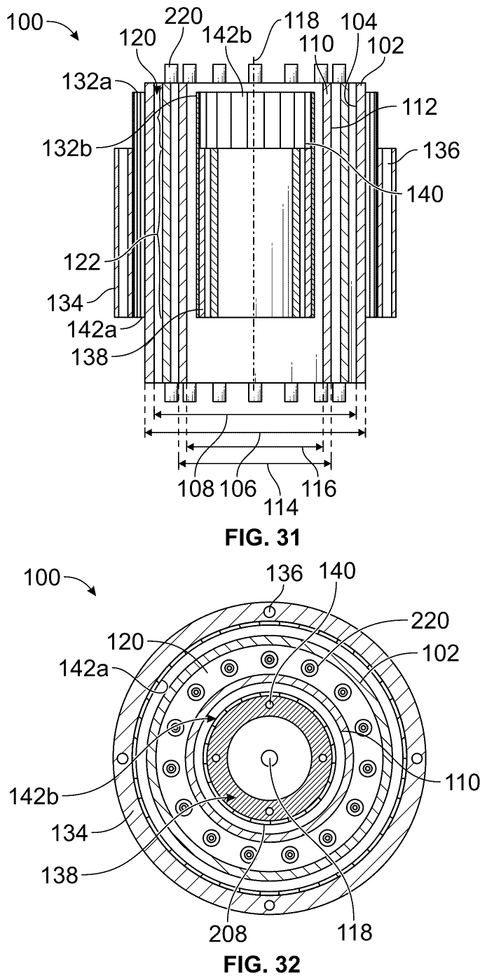

FIG. 30 is an isometric diagram illustrating a photocatalytic reactor cell assembly 100 with embedded IR heaters 220, according to an example embodiment. FIG. 31 is a vertical cross-sectional diagram illustrating a photocatalytic reactor cell assembly 100 with embedded IR heaters 220, according to an example embodiment. FIG. 32 is a horizontal cross-sectional diagram illustrating a photocatalytic reactor cell assembly 100 with embedded IR heaters 220, according to an example embodiment. FIGS. 30-32 may omit some features and/or components from what is shown in various other figures described herein (or each other), as appropriate, to permit better illustration and comprehension. For example, FIGS. 30-32 omit (but the described example embodiments may include) at least the photocatalyst packed bed 126, porous base filter 130, reactant gas inlet 146, and product gas outlet 158. FIGS. 30-32 are presented primarily to illustrate a variation of the photocatalytic reactor cell assembly 100 in which a plurality of (e.g., two or more, three or more, four or more, or other numbers) of IR heaters 220 are embedded in the annular volume 120 between the outer cell wall 102 and the inner cell wall 110 to provide beneficial heating to portions of the photocatalytic reactor cell assembly 100, such as the photocatalyst packed bed 126 (not shown). Use of embedded IR lamps as heaters allows for direct contact with the catalyst in the annular volume 120, providing both radiative and conductive heat transfer and reducing heat losses. Such a configuration additionally allows for higher watt density at high temperatures, making it highly suitable for very high endothermic reactions like Photocatalytic Dry Methane Reforming (PDMR).

With the exception of the embedded IR heaters 220, all components illustrated in FIGS. 29-31 are similar or identical to those illustrated in FIGS. 1-3 and are numbered accordingly. Further details regarding such components are described elsewhere herein. In example embodiments, each of the IR heaters 220 may be similar to or identical to the IR lamps described with reference to FIGS. 9-22, and in particular FIG. 12. However, the reflective coating 186 illustrated in FIG. 13 might be excluded, at least for portions of the IR heaters 220 that are adjacent to the photocatalyst bed 126. As illustrated, the photocatalytic reactor cell assembly 100 includes a plurality of infrared (IR) lamps arranged adjacent to one another annularly around the vertical axis between the inner cell wall and the outer cell wall. A plurality of IR heaters 220 distributed uniformly throughout the annular volume 120 may advantageously apply consistent heating throughout the annular volume 120. Including relatively more IR heaters 220 may provide more heating, but also presents a tradeoff in the form of less available space in the annular volume 120 for the photocatalyst packed bed 126. In the embodiment illustrated in FIGS. 30-32, the portion of the annular volume 120 occupied by the IR heaters 220 is approximately one-fourth or less. Other portions may be appropriate for certain reactor cell geometries, such as for relatively smaller or larger IR lamps compared to thickness of the annular volume 120.

### K. Example Reactions and Associated Reaction Conditions

The various reactor cell assembly embodiments set forth herein may serve as a platform technology allowing for multiple gas-phase chemical reactions on a solid catalyst, including reactions requiring high enthalpy of reaction and high activation energy via the use of light energy. For example, the following are some of the reactions and reaction types possible using one or more example embodiments set forth herein: steam methane reforming; dry methane reforming; partial oxidation of methane; autothermal reforming; decomposition of ammonia; ammonia synthesis; water gas shift reactions; reforming of heavier hydrocarbons (e.g., alkylated cyclics, resins and asphaltenes); Fischer-Tropsch synthesis; methanol synthesis; ethanol synthesis; hydrogenation to make saturated compounds; and dehydrogenation to make ethylene. Other gas-phase reactions and reaction types are also possible using various embodiments set forth herein.

Tables 2 and 3, below, illustrate example reaction condition ranges for two example chemical reactions that can be used for performing chemical reactions in various embodiments of the reactor cell set forth herein.

### Photocatalytic Steam Methane Reforming (Multiple Embodiments):

TABLE 2

| Reaction Condition | Unit | Range |
|---|---|---|
| GHSV | h⁻¹ | 2000-12000 |
| Steam:Methane ratio | — | 1-4 |
| Temperature | ° C. | 150-750 |
| Pressure | PSIA | 15-200 |
| Light Intensity | W/cm² | 1-10 |

### Photocatalytic Decomposition of Ammonia (Multiple Embodiments):

TABLE 3

| Reaction Condition | Unit | Range |
|---|---|---|
| GHSV | h⁻¹ | 2000-25000 |
| Temperature | ° C. | 100-600 |
| Pressure | PSIA | 15-100 |
| Light Intensity | W/cm² | 1-10 |

Tables 4 and 5, below, illustrate example hydrogen production rates by catalyst bed volume for various example reactor cell embodiments set forth herein.

### Photocatalytic Steam Methane Reforming (Some Embodiments):

TABLE 4

| Catalyst Bed | Hydrogen Production |
|---|---|
| Volume (L) | Rate (kg/day) |
| 0.25 | 3.2 |
| 15 | 200 |

### Photocatalytic Decomposition of Ammonia (Some Embodiments):

TABLE 5

| Catalyst Bed | Hydrogen Production |
|---|---|
| Volume (L) | Rate (kg/day) |
| 0.25 | 3.4 |
| 15 | 204 |

### L. Multiphysics Simulation Modeling and Experimental Results

COMSOL modeling was used to model light delivery to the photocatalyst bed for various light housing designs for an annular-shaped reactor cell assembly. This modeling has demonstrated that in some embodiments, an LED-based inner portion of the light housing (i.e., the interior of the annulus of the annular-shaped reactor) is capable of delivering approximately 63% of input electrical energy to the photocatalyst bed, when considering driver loss, electrical-to-heat loss at diode, and light housing loss. Similarly, the modeling demonstrated that an LED-based outer portion of the light housing (i.e., the exterior of the annulus of the annular-shaped reactor) is capable of delivery approximately 55% of input electrical energy to the photocatalyst bed, when considering driver loss, electrical-to-heat loss at diode, and light housing loss. Theoretical calculations were also performed to estimate IR lamp energy delivery efficiency. Based on these theoretical calculations, an example maximum IR energy efficiency to be achieved using various example embodiments disclosed herein is 75%.

To find the light intensity incident on the photocatalyst packed bed 126 and the efficiency of the light housing (inner and/or outer portions), a COMSOL ray-tracing simulation has been employed. Each LED (out of thousands or more of LEDs) acts as a point sources of light and emits radiation in the visible spectrum with a certain emissive power. The COMSOL simulation traces representative rays through a geometry representing the light housing and other components of the reactor cell assembly 100. The traced light rays bounce off surfaces based off Snell's law and the Fresnel equations. Each ray loses some energy with each boundary interaction and eventually falls below a certain energy threshold and stops propagating. The photocatalyst packed bed 126 is simulated as highly absorptive so that if a traced ray reaches the photocatalyst 126, it is completely absorbed for purposes of the COMSOL simulation.

The rays emitted from each individual LED (or other light source) are traced, and once all representative rays for all LEDs have been traced through the light housing geometry, the accumulated energy (in watts) that is deposited at each boundary is then divided by the area of the underlying mesh (e.g., a finite element mesh comprising triangles). This gives an intensity at each surface (e.g., triangular mesh surface segment) that may be used as a heat source for further heat transfer/fluid flow simulations. Mathematically, the resulting light intensity on any triangular mesh surface is:

$${I}_{i} = \frac{1}{{A}_{i}} {\sum }_{j} {Q}_{j} \qquad Equation 2$$

where I is intensity in W/m², A is area in m², and Q is the power of a ray in W. Here the subscript i represents the index of mesh triangle and the subscript j represents the index of rays that have accumulated on that specific mesh triangle.

Table 6, below, illustrates experimental results and design calculations demonstrating performance of example embodiments of the reactor cell assembly set forth herein, using Photocatalytic Steam Methane Reformation (PSMR) as an example reaction. As can be seen, the conversion percentage is 83% for both experimental results and design calculations, which is believed to be a significant improvement over typical hydrogen-producing reactors.

TABLE 6

| | Experimental | Design |
|---|---|---|
| | Results | calculations |
| Reactor volume (L) | 0.013 | 0.263 |
| GHSV (h⁻¹) | 6500 | 6500 |
| Steam:Methane Ratio | 2 | 2 |
| Hydrogen Generated | 0.175 | 3.4 |
| (Kg/day) | | |
| Conversion (%) | 83% | 83% |
| Energy Efficiency (%) | 40% | 50% |
| Electrical Energy | 407 | 5000 |
| used (W) | | |

### III. Examples

The following numbered examples are embodiments.

1. A photocatalytic reactor cell assembly, comprising: an outer cell wall comprising a first tube having a first outer diameter and a first inner diameter; an inner cell wall comprising a second tube having a second outer diameter and a second inner diameter, wherein the second outer diameter is smaller than the first inner diameter, and wherein the outer cell wall and the inner cell wall are arranged concentrically about a vertical axis to define an annular volume between the outer cell wall and the inner cell wall; a top compression endcap fitting having an annular shape and comprising a reactant gas inlet; a bottom compression endcap fitting having an annular shape and comprising a product gas outlet, wherein the top compression endcap fitting and the bottom compression endcap fittings respectively form a top seal and a bottom seal with the outer cell wall and the inner cell wall; a photocatalyst packed bed positioned in the annular volume between the outer cell wall and the inner cell wall, wherein the photocatalyst packed bed comprises a photocatalyst; a porous base filter to position the photocatalyst packed bed in the annular volume, wherein the porous base filter is on an underside of the photocatalyst packed bed closer to the bottom compression endcap fitting than to the top compression endcap fitting, and wherein the porous base filter has a pore size chosen to be gas permeable but impermeable to the photocatalyst in the photocatalyst packed bed; and a light housing comprising an outer portion and an inner portion, wherein the outer portion is arranged concentrically around the vertical axis outside the outer cell wall, wherein the inner portion is arranged concentrically around the vertical axis inside the inner cell wall, and wherein at least one of the outer portion and the inner portion comprises a circumferential array of photon emitters arranged to uniformly emit photons incident on the photocatalyst packed bed, whereby the emission of photons incident on the photocatalyst packed bed activates continuous photo-induced gas-phase reactions as at least one gaseous reactant introduced via the gas inlet flows through the photocatalyst packed bed and at least one resultant gaseous product exits via the gas outlet.

2. The photocatalytic reactor cell assembly of example 1, wherein the first tube is cylindrical.

3. The photocatalytic reactor cell assembly of example 1 or example 2, wherein the first tube has a circular cross section.

4. The photocatalytic reactor cell assembly of any of the preceding examples, wherein the second tube is cylindrical.

5. The photocatalytic reactor cell assembly of any of the preceding examples, wherein the second tube has a circular cross section.

6. The photocatalytic reactor cell assembly of any of the preceding examples, wherein the first tube and the second tube are cylindrical.

7. The photocatalytic reactor cell assembly of any of the preceding examples, wherein the first tube and the second tube have a circular cross section.

8. The photocatalytic reactor cell assembly of any of the preceding examples, wherein at least a portion of at least one of the outer cell wall and the inner cell wall is constructed of a material that is transparent to the photons emitted by the photon emitters.

9. The photocatalytic reactor cell assembly of any of the preceding examples, wherein at least a portion of at least one of the outer cell wall and the inner cell wall is transparent to photons in the visible light spectrum.

10. The photocatalytic reactor cell assembly of any of the preceding examples, wherein at least a portion of at least one of the outer cell wall and the inner cell wall is transparent to photons in the near-IR spectrum.

11. The photocatalytic reactor cell assembly of any of the preceding examples, wherein at least one of the outer cell wall and the inner cell wall comprises glass tubing.

12. The photocatalytic reactor cell assembly of any of the preceding examples, wherein at least one of the outer cell wall and the inner cell wall comprises fused quartz glass.

13. The photocatalytic reactor cell assembly of any of the preceding examples, wherein at least one of the outer cell wall and the inner cell wall comprises borosilicate glass.

14. The photocatalytic reactor cell assembly of any of the preceding examples, wherein at least one of the outer cell wall and the inner cell wall comprises a metallic material.

15. The photocatalytic reactor cell assembly of any of the preceding examples, wherein at least a first portion of at least one of the outer cell wall and the inner cell wall is constructed of a material that is transparent to the photons emitted by the photon emitters, and wherein at least a second portion of at least one of the outer cell wall and the inner cell wall comprises a reflective surface to reflect emitted photons into the photocatalyst packed bed.

16. The photocatalytic reactor cell assembly of any of the preceding examples, wherein at least a first portion of at least one of the outer cell wall and the inner cell wall is constructed of a material that is transparent to the photons emitted by the photon emitters, and wherein at least a second portion of at least one of the outer cell wall and the inner cell wall comprises a scattering surface to scatter emitted photons into the photocatalyst packed bed.

17. The photocatalytic reactor cell assembly of any of the preceding examples, wherein the photocatalyst packed bed comprises the photocatalyst co-precipitated with a support material.

18. The photocatalytic reactor cell assembly of any of the preceding examples, wherein the photocatalyst comprises antenna-reactor plasmonic nanoparticles.

19. The photocatalytic reactor cell assembly of any of the preceding examples, wherein the photocatalyst packed bed is positioned vertically in a middle portion of the annular volume, and wherein an upper portion of the annular volume closest to the top compression endcap fitting is devoid of the photocatalyst packed bed to provide sufficient headspace for reactant gas mixing.

20. The photocatalytic reactor cell assembly of any of the preceding examples, wherein the top compression endcap fitting and the bottom compression endcap fitting are constructed of stainless steel (SS316).

21. The photocatalytic reactor cell assembly of any of examples 1-19, wherein the top compression endcap fitting and the bottom compression endcap fitting are constructed of an austenitic nickel-chromium-based alloy.

22. The photocatalytic reactor cell assembly of any of examples 1-19, wherein the top compression endcap fitting and the bottom compression endcap fitting are constructed of a nickel-chromium-iron-molybdenum alloy.

23. The photocatalytic reactor cell assembly of any of examples 1-19, wherein the top compression endcap fitting and the bottom compression endcap fitting are constructed of aluminum.

24. The photocatalytic reactor cell assembly of any of the preceding examples, wherein a portion of at least one of the top compression endcap fitting and the bottom compression endcap fitting facing the photocatalyst packed bed is polished to reflect emitted photons into the photocatalyst packed bed.

25. The photocatalytic reactor cell assembly of any of the preceding examples, wherein the top compression endcap fitting has at least one of a first outer circumferential flange to fit around a top portion of the outer cell wall or a first inner circumferential flange to fit inside a top portion of the inner cell wall.

26. The photocatalytic reactor cell assembly of any of the preceding examples, wherein the bottom compression endcap fitting has at least one of a second outer circumferential flange to fit around a bottom portion of the outer cell wall or a second inner circumferential flange to fit inside a bottom portion of the inner cell wall.

27. The photocatalytic reactor cell assembly of any of the preceding examples, further comprising a tension rod coupled to each of the top compression endcap fitting and the bottom compression endcap fitting to exert a compression force sufficient to cause the top seal and the bottom seal to be formed.

28. The photocatalytic reactor cell assembly of example 27, wherein the tension rod is arranged to be co-linear with the vertical axis about which the outer cell wall and the inner cell wall are concentrically arranged, and wherein the tension rod comprises threads cooperating with at least one threaded fastener to facilitate tightening of the top compression endcap fitting and the bottom compression endcap fitting onto the outer cell wall and the inner cell wall.

29. The photocatalytic reactor cell assembly of example 27 or example 28, wherein the top compression endcap fitting and the bottom compression endcap fitting each comprise a support through which the tension rod exerts the compression force.

30. The photocatalytic reactor cell assembly of example 29, wherein the tension rod and the supports are constructed of aluminum.

31. The photocatalytic reactor cell assembly of any of the preceding examples, further comprising a plurality of tension rods coupled to each of the top compression endcap fitting and the bottom compression endcap fitting to exert a compression force sufficient to cause the top seal and the bottom seal to be formed.

32. The photocatalytic reactor cell assembly of any of the preceding examples, further comprising at least one gasket to assist in causing at least one of the top seal or the bottom seal to be formed.

33. The photocatalytic reactor cell assembly of any of the preceding examples, further comprising at least one O-ring to assist in causing at least one of the top seal or the bottom seal to be formed.

34. The photocatalytic reactor cell assembly of any of the preceding examples, wherein the outer portion of the light housing is cylindrical.

35. The photocatalytic reactor cell assembly of any of the preceding examples, wherein the outer portion of the light housing has a circular cross section.

36. The photocatalytic reactor cell assembly of any of the preceding examples, wherein the inner portion of the light housing is cylindrical.

37. The photocatalytic reactor cell assembly of any of the preceding examples, wherein the inner portion of the light housing has a circular cross section.

38. The photocatalytic reactor cell assembly of any of the preceding examples, wherein the inner portion of the light housing and the outer portion of the light housing are cylindrical.

39. The photocatalytic reactor cell assembly of any of the preceding examples, wherein the outer portion of the light housing and the inner portion of the light housing have a circular cross section.

40. The photocatalytic reactor cell assembly of any of the preceding examples, wherein at least one of the outer portion of the light housing or the inner portion of the light housing comprises an aluminum frame upon which the circumferential array of photon emitters is mounted.

41. The photocatalytic reactor cell assembly of any of the preceding examples, wherein at least one of the outer portion of the light housing or the inner portion of the light housing comprises a cooling block upon which the circumferential array of photon emitters is mounted, and wherein the cooling block has at least one cooling passage through which a cooling fluid passes.

42. The photocatalytic reactor cell assembly of any of the preceding examples, wherein the cooling block comprises walls defining a receptacle through which the cooling fluid is passed at a predetermined flow rate.

43. The photocatalytic reactor cell assembly of any of the preceding examples, wherein the cooling fluid has a predetermined heat capacity.

44. The photocatalytic reactor cell assembly of any of the preceding examples, wherein the circumferential array of photon emitters comprises a plurality of LEDs mounted on at least one of the aluminum walls of the cooling block, whereby the cooling fluid passing through the receptacle assists in cooling the plurality of LEDs.

45. The photocatalytic reactor cell assembly of any of the preceding examples, wherein the circumferential array of photon emitters comprises a plurality of LEDs, and wherein at least one of the cylindrical shell of the light housing or the inner portion of the light housing comprises a cooling block having at least one of a plurality of coolant passages of a plurality of baffles for passing a cooling fluid through the aluminum cooling block to assist in cooling the plurality of LEDs.

46. The photocatalytic reactor cell assembly of any of the preceding examples, wherein the outer portion comprises an outer cooling block and the inner portion comprises an inner cooling block, the outer cooling block and the inner cooling block being configured to assist in cooling the photon emitters.

47. The photocatalytic reactor cell assembly of any of the preceding examples, wherein the outer portion of the light housing comprises the circumferential array of photon emitters arranged on an inner surface of the outer portion to uniformly emit photons incident on the photocatalyst packed bed.

48. The photocatalytic reactor cell assembly of any of the preceding examples, wherein the inner portion of the light housing comprises the circumferential array of photon emitters arranged on an outer surface of the inner portion to uniformly emit photons incident on the photocatalyst packed bed.

49. The photocatalytic reactor cell assembly of any of the preceding examples, wherein the outer portion of the light housing comprises a first portion of the circumferential array of photon emitters arranged on an inner surface of the outer portion to uniformly emit photons incident on the photocatalyst packed bed, and wherein the inner portion of the light housing comprises a second portion of the circumferential array of photon emitters arranged on an outer surface of the inner portion to uniformly emit photons incident on the photocatalyst packed bed.

50. The photocatalytic reactor cell assembly of any of the preceding examples, wherein the outer portion of the light housing is of a clamshell design and comprises two sections coupled by a hinge to allow for installation or removal of the outer portion in the photocatalytic reactor cell assembly.

51. The photocatalytic reactor cell assembly of any of the preceding examples, wherein the inner portion of the light housing fastens to the tension rod.

52. The photocatalytic reactor cell assembly of any of the preceding examples, wherein the outer portion and the inner portion are each connected to at least one of the supports on at least one of the top compression endcap fitting and the bottom compression endcap fitting.

53. The photocatalytic reactor cell assembly of example 52, wherein the supports are constructed of aluminum.

54. The photocatalytic reactor cell assembly of any of the preceding examples, wherein the light housing is fluid-cooled.

55. The photocatalytic reactor cell assembly of any of the preceding examples, wherein the light housing is water-cooled.

56. The photocatalytic reactor cell assembly of any of the preceding examples in which the photon emitters are LEDs, wherein the light housing comprises a cooling system to maintain a surface on which the photon emitters are mounted at a temperature not exceeding 150 degrees Celsius.

57. The photocatalytic reactor cell assembly of any of the preceding examples, wherein the light housing comprises at least one heat sink.

58. The photocatalytic reactor cell assembly of example 57, wherein the heat sink is constructed of aluminum.

59. The photocatalytic reactor cell assembly of any of the preceding examples, wherein the light housing further comprises integrated control electronics to control the photon emitters.

60. The photocatalytic reactor cell assembly of any of the preceding examples, wherein both the outer portion and the inner portion have annular cross sections.

61. The photocatalytic reactor cell assembly of any of the preceding examples, wherein the circumferential array of photon emitters comprises a plurality of LED boards adjacent to one another, each LED board comprising a plurality of LEDs.

62. The photocatalytic reactor cell assembly of any of the preceding examples, wherein the photon emitters are selected to emit photons having a sufficient energy and wavelength to activate the photo-induced gas-phase reactions.

63. The photocatalytic reactor cell assembly of any of the preceding examples, wherein the photon emitters comprise Light-Emitting Diodes (LED) to emit photons in the visible light spectrum.

64. The photocatalytic reactor cell assembly of any of the preceding examples, wherein the photon emitters comprise Infrared (IR) lamps to emit photons in the near-IR spectrum.

65. The photocatalytic reactor cell assembly of any of the preceding examples, wherein the photon emitters are selected from the group consisting of UV lamps, IR lamps, arc lamps, or LEDs.

66. The photocatalytic reactor cell assembly of any of the preceding examples, further comprising drivers for the photon emitters, wherein the drivers are selected to operate at 50% or greater power load in order to improve driver efficiency.

67. The photocatalytic reactor cell assembly of any of the preceding examples, wherein the circumferential array of photon emitters comprises a plurality of infrared (IR) lamps arranged adjacent to one another annularly around the vertical axis.

68. The photocatalytic reactor cell assembly of any of the preceding examples, wherein the outer portion comprises the circumferential array of photon emitters in form of infrared (IR) lamps arranged adjacent to one another annularly around the vertical axis and outside of the outer cell wall, wherein each IR lamp comprises a reflective coating to reflect IR radiation toward the photocatalytic packed bed, and wherein the reflective coating of each IR lamp is on a surface of the IR lamp distal from the vertical axis.

69. The photocatalytic reactor cell assembly of any of the preceding examples, wherein the inner portion comprises the circumferential array of photon emitters in form of infrared (IR) lamps arranged adjacent to one another annularly around the vertical axis and inside of the inner cell wall, wherein each IR lamp comprises a reflective coating to reflect IR radiation toward the photocatalytic packed bed, and wherein the reflective coating of each IR lamp is on a surface of the IR lamp proximal to the vertical axis.

70. The photocatalytic reactor cell assembly of any of the preceding examples, wherein the porous base filter comprises a gas-permeable structural material.

71. The photocatalytic reactor cell assembly of any of the preceding examples, wherein the porous base filter comprises at least one of porous metal, quartz wool, or ceramic.

72. The photocatalytic reactor cell assembly of any of the preceding examples, wherein the porous base filter comprises stainless steel (SS316), an austenitic nickel-chromium-based alloy, or a nickel-chromium-iron-molybdenumm alloy.

73. The photocatalytic reactor cell assembly of any of the preceding examples, wherein the porous base filter has an annular shape.

74. The photocatalytic reactor cell assembly of any of the preceding examples, further comprising a heater to heat the annular volume, thereby increasing the reaction rate of the photo-induced gas-phase reactions.

75. The photocatalytic reactor cell assembly of any of the preceding examples, wherein the outer portion of the light housing is a heater that heats the annular volume to thereby increase the reaction rate of the photo-induced gas-phase reaction.

76. The photocatalytic reactor cell assembly of example 74 or example 75, wherein the heater is selected from a tube furnace heater or a band heater.

77. The photocatalytic reactor cell assembly of any of the preceding examples, further comprising an immersion infrared (IR) coil lamp disposed in a helical quartz tube in the annular volume.

78. The photocatalytic reactor cell assembly of any of the preceding examples, further comprising a heater embedded in the annular volume, wherein the heater comprises a plurality of infrared (IR) lamps arranged adjacent to one another annularly around the vertical axis between the inner cell wall and the outer cell wall.

79. The photocatalytic reactor cell assembly of any of the preceding examples, further comprising an annular heater immersed in the annular volume.

80. The photocatalytic reactor cell assembly of any of the preceding examples, wherein at least one of the first tube or the second tube comprises a plurality of cylindrical portions having different diameters, and wherein the cylindrical portions are joined end-to-end via angular connecting portions.

### IV. Conclusion

The above detailed description sets forth various features and operations of the disclosed systems, apparatus, devices, and/or methods with reference to the accompanying figures. The example embodiments described herein and in the figures are not meant to be limiting, with the true scope being indicated by the following claims. Many modifications and variations can be made without departing from its scope, as will be apparent to those skilled in the art. Functionally equivalent systems, apparatus, devices, and/or methods within the scope of the disclosure, in addition to those described herein, will be apparent to those skilled in the art from the foregoing descriptions. It will be readily understood that the aspects of the present disclosure, as generally described herein, and illustrated in the figures, can be arranged, substituted, combined, separated, and designed in a wide variety of different configurations. Such modifications and variations are intended to fall within the scope of the appended claims. Finally, all publications, patents, and patent applications cited herein are hereby incorporated herein by reference for all purposes.

1. A photocatalytic reactor cell assembly, comprising:
an outer cell wall comprising a first tube having a first outer diameter and a first inner diameter;
an inner cell wall comprising a second tube having a second outer diameter and a second inner diameter, wherein the second outer diameter is smaller than the first inner diameter, and wherein the outer cell wall and the inner cell wall are arranged concentrically about a vertical axis to define an annular volume between the outer cell wall and the inner cell wall;
a top compression endcap fitting having an annular shape and comprising a reactant gas inlet;
a bottom compression endcap fitting having an annular shape and comprising a product gas outlet, wherein the top compression endcap fitting and the bottom compression endcap fitting respectively form a top seal and a bottom seal with the outer cell wall and the inner cell wall;
a photocatalyst packed bed positioned in the annular volume between the outer cell wall and the inner cell wall, wherein the photocatalyst packed bed comprises a photocatalyst;
a porous base filter to position the photocatalyst packed bed in the annular volume, wherein the porous base filter is on an underside of the photocatalyst packed bed closer to the bottom compression endcap fitting than to the top compression endcap fitting, and wherein the porous base filter has a pore size chosen to be gas permeable but impermeable to the photocatalyst in the photocatalyst packed bed; and
a light housing comprising an outer portion and an inner portion, wherein the outer portion is arranged concentrically around the vertical axis outside the outer cell wall, wherein the inner portion is arranged concentrically around the vertical axis inside the inner cell wall, and wherein at least one of the outer portion or the inner portion comprises a circumferential array of photon emitters arranged to uniformly emit photons incident on the photocatalyst packed bed,
whereby the emission of photons incident on the photocatalyst packed bed activates continuous photo-induced gas-phase reactions as at least one gaseous reactant introduced via the gas inlet flows through the photocatalyst packed bed and at least one resultant gaseous product exits via the gas outlet.

2-6. (canceled)

7. The photocatalytic reactor cell assembly of claim 1, wherein the first tube and the second tube have a circular cross section.

8. The photocatalytic reactor cell assembly of claim 1, wherein at least a portion of at least one of the outer cell wall or the inner cell wall is constructed of a material that is transparent to the photons emitted by the photon emitters.

9-11. (canceled)

12. The photocatalytic reactor cell assembly of claim 1, wherein at least one of the outer cell wall or the inner cell wall comprises fused quartz glass, borosilicate glass, a metallic material, or glass tubing.

13-14. (canceled)

15. The photocatalytic reactor cell assembly of claim 1, wherein at least a first portion of at least one of the outer cell wall or the inner cell wall is constructed of a material that is transparent to the photons emitted by the photon emitters, and wherein at least a second portion of at least one of the outer cell wall or the inner cell wall comprises a reflective surface to reflect emitted photons into the photocatalyst packed bed.

16. (canceled)

17. The photocatalytic reactor cell assembly of claim 1, wherein the photocatalyst packed bed comprises the photocatalyst co-precipitated with a support material.

18. (canceled)

19. The photocatalytic reactor cell assembly of claim 1, wherein the photocatalyst packed bed is positioned vertically in a middle portion of the annular volume, and wherein an upper portion of the annular volume closest to the top compression endcap fitting is devoid of the photocatalyst packed bed to provide sufficient headspace for reactant gas mixing.

20. The photocatalytic reactor cell assembly of claim 1, wherein the top compression endcap fitting and the bottom compression endcap fitting are constructed of stainless steel (SS316), an austenitic nickel-chromium-bases alloy, a nickel-chromium-iron-molybdenum allow, or aluminum.

21-26. (canceled)

27. The photocatalytic reactor cell assembly of claim 1, further comprising a tension rod coupled to each of the top compression endcap fitting and the bottom compression endcap fitting to exert a compression force sufficient to cause the top seal and the bottom seal to be formed.

28-31. (canceled)

32. The photocatalytic reactor cell assembly of claim 1, further comprising at least one gasket to assist in causing at least one of the top seal or the bottom seal to be formed.

33. The photocatalytic reactor cell assembly of claim 1, further comprising at least one O-ring to assist in causing at least one of the top seal or the bottom seal to be formed.

34-38. (canceled)

39. The photocatalytic reactor cell assembly of claim 1, wherein the outer portion of the light housing and the inner portion of the light housing have a circular cross section.

40. (canceled)

41. The photocatalytic reactor cell assembly of claim 1, wherein at least one of the outer portion of the light housing or the inner portion of the light housing comprises a cooling block upon which the circumferential array of photon emitters is mounted, and wherein the cooling block has at least one cooling passage through which a cooling fluid passes.

42. The photocatalytic reactor cell assembly of claim 1, wherein the cooling block comprises aluminum walls defining a receptacle through which the cooling fluid is passed at a predetermined flow rate.

43-45. (canceled)

46. The photocatalytic reactor cell assembly of claim 1, wherein the outer portion comprises an outer cooling block and the inner portion comprises an inner cooling block, the outer cooling block and the inner cooling block being configured to assist in cooling the photon emitters.

47. The photocatalytic reactor cell assembly of claim 1, wherein the outer portion of the light housing comprises the circumferential array of photon emitters arranged on an inner surface of the outer portion to uniformly emit photons incident on the photocatalyst packed bed.

48. The photocatalytic reactor cell assembly of claim 1, wherein the inner portion of the light housing comprises the circumferential array of photon emitters arranged on an outer surface of the inner portion to uniformly emit photons incident on the photocatalyst packed bed.

49. The photocatalytic reactor cell assembly of claim 1, wherein the outer portion of the light housing comprises a first portion of the circumferential array of photon emitters arranged on an inner surface of the outer portion to uniformly emit photons incident on the photocatalyst packed bed, and wherein the inner portion of the light housing comprises a second portion of the circumferential array of photon emitters arranged on an outer surface of the inner portion to uniformly emit photons incident on the photocatalyst packed bed.

50-51. (canceled)

52. The photocatalytic reactor cell assembly of claim 1, wherein the outer portion and the inner portion are each connected to at least one support on at least one of the top compression endcap fitting or the bottom compression endcap fitting.

53-58. (canceled)

59. The photocatalytic reactor cell assembly of claim 1, wherein the light housing further comprises integrated control electronics to control the photon emitters.

60-61. (canceled)

62. The photocatalytic reactor cell assembly of claim 1, wherein the photon emitters are selected to emit photons having a sufficient energy and wavelength to activate the photo-induced gas-phase reactions.

63-64. (canceled)

65. The photocatalytic reactor cell assembly of claim 1, wherein the photon emitters comprise UV lamps, IR lamps, arc lamps, or LEDs.

66. (canceled)

67. The photocatalytic reactor cell assembly of claim 1, wherein the circumferential array of photon emitters comprises a plurality of infrared (IR) lamps arranged adjacent to one another annularly around the vertical axis.

68. The photocatalytic reactor cell assembly of claim 1, wherein the outer portion comprises the circumferential array of photon emitters in form of infrared (IR) lamps arranged adjacent to one another annularly around the vertical axis and outside of the outer cell wall, wherein each IR lamp comprises a reflective coating to reflect IR radiation toward the photocatalyst packed bed, and wherein the reflective coating of each IR lamp is on a surface of the IR lamp distal from the vertical axis.

69. The photocatalytic reactor cell assembly of claim 1, wherein the inner portion comprises the circumferential array of photon emitters in form of infrared (IR) lamps arranged adjacent to one another annularly around the vertical axis and inside of the inner cell wall, wherein each IR lamp comprises a reflective coating to reflect IR radiation toward the photocatalyst packed bed, and wherein the reflective coating of each IR lamp is on a surface of the IR lamp proximal to the vertical axis.

70. The photocatalytic reactor cell assembly of claim 1, wherein the porous base filter comprises a gas-permeable structural material.

71-76. (canceled)

77. The photocatalytic reactor cell assembly of claim 1, further comprising an immersion infrared (IR) coil lamp disposed in a helical quartz tube in the annular volume.

78. The photocatalytic reactor cell assembly of any claim 1, further comprising a heater embedded in the annular volume, wherein the heater comprises a plurality of infrared (IR) lamps arranged adjacent to one another annularly around the vertical axis between the inner cell wall and the outer cell wall.

79. (canceled)

80. The photocatalytic reactor cell assembly of claim 1, wherein at least one of the first tube or the second tube comprises a plurality of cylindrical portions having different diameters, and wherein the cylindrical portions are joined end-to-end via angular connecting portions.
